(19) United States
(12) Patent Application Publication
(10) Pub. No.: US 2012/0185372 A1
(43) Pub. Date: Jul. 19, 2012

(54) EXCHANGE TRADED ASSET BASED SECURITY

(76) Inventor: Christopher James Lougher McIntosh, Hawthorn Vic (AU)

(21) Appl. No.: 13/343,323

(22) Filed: Jan. 4, 2012

Related U.S. Application Data
(63) Continuation-in-part of application No. 12/088,290, filed on Sep. 24, 2008, now abandoned.

(30) Foreign Application Priority Data
Sep. 28, 2005 (AU) 2005/905331

(51) Int. Cl. G06Q 40/04

(52) U.S. Cl. 705/37

(57) ABSTRACT

Aspects of this invention provide a security and an index that may be based on any asset or derivative asset or a combination of these including but not limited to a commodity, a debt issuance, a currency, an equity or a basket or an index of any of these that has a forward (or term) price structure, a forward contract market, an expiration date and can be rolled forward. The security is designed to meet the specific needs of investors and offer unique risk/return characteristics. The exchange traded, structured investment security is based on an asset and is linked through its entitlement to the value or performance of the asset as measured by an index. The asset has a forward price structure, a forward market, an expiration date and is able to be rolled forward into another asset with a later expiry date.

### PRIORITY

Priority is claimed as a continuation-in-part application to U.S. patent application Ser. No. 12/088,290, filed Sep. 24, 2008, which claims priority as a national stage application to PCT/AU2006/001408, filed Sep. 20, 2006, which claims priority to Australian Patent Application No. 2005/905331, filed on Sep. 28, 2005. The disclosures of the aforementioned priority applications are incorporated herein by reference in their entirety.

### FIELD OF THE INVENTION

This invention relates to a computer based system and a computer network system that enable an asset based security and an index to be created and managed. The security may be exchange traded utilizing an electronic computer based network system and may be based on assets such as commodities and currencies. The index provides continuous tracking of the value of the asset based security.

### BACKGROUND TO THE INVENTION

Traditional asset classes for investment include equities, bonds and property (trusts/investment funds). Traditional asset investments derive returns from the changes in the price level of the asset—a ‘price return’ plus a ‘yield return’ if any (e.g. interest, dividend, rent or similar) less any transaction and carrying costs. Risk adjusted returns are improved through diversification, increasing the number of component assets and the number of different asset classes held. Commodities represent an alternative asset class with attractive investment attributes because commodity returns are either uncorrelated (independent of), or more beneficially negatively correlated (generally) with equities and bond returns that can provide portfolio diversifying, performance enhancing, risk adjusted returns. Investment returns based on futures are characteristically different to a stock or a physical commodity for example, since futures contracts expire. To remain invested in futures, a futures contract near expiration needs to be rolled prior to expiration, into a futures contract of longer maturity. The roll process of a long futures contract combined with the term structure of futures contract prices gives rise to an investment return from the roll process referred to as the roll return or roll yield that may be positive (backwardation), negative (contango) or zero (flat). Access to commodities is limited for many investment market participants because they are not associated with the physical market and specialist expertise is often needed for commodity futures and associated derivatives, suitable investable (particularly exchange tradable) securities do not exist, practical considerations require for example a large initial investment size or alternatives are not cost effective, efficient and transparent, or are limited or prohibited by mandate or regulation from investing in securities other than stock exchange listed securities and certain other financial instruments.

Ways to access securities that have historically provided an investment exposure to commodities for example, have included:
OTC
   commodity derivatives (eg. options, warrants, swaps)
   securities and certificates based on indices or baskets comprising one or more physical commodities, commodity futures, commodity funds and CTA accounts
   index and managed futures funds and CTA accounts
   hedge funds
On a regulated stock exchange (historically very few):
   individual shares of listed companies engaged in a commodity oriented business
   listed commodity oriented investment funds and ETF's of portfolios of listed shares of commodity oriented companies
   discrete issuances (very few) with a forward maturity linked to an index e.g. commodity price-linked debt (designed to enhance corporate funding), commodity warrants, physicals and synthetic commodities trusts
   ETF's (exchange traded funds) structure (recent)
      portfolios of listed shares of commodity oriented companies (a traditional stock based ETF)
      based on a stored physical commodity—the first pure commodity ETF was in gold in 2003 (Gold Bullion Securities) where a redeemable securities were issued against gold bullion held on trust
On a regulated physicals exchange
   Metals on the London Metals Exchange
On a regulated futures exchange:
   commodity futures and derivatives futures contracts based on a commodity index—e.g. GSCI futures, CRB Index futures.

Futures based indices on which investable securities are based are theoretical constructs and typically do not reflect the actual returns from investing in futures. There have been various indices developed to measure the performance of an investment in assets such as commodities. Indices have included Total Return, Excess Return and Spot Market Price indices. Goldman Sachs developed the GSCI Total Return (GSCI-TR) index, a theoretical measure of a fully collateralized investment in commodity futures. It measures investment returns from futures contracts which are leveraged and a collateral yield from the funds invested at the risk free rate. It has been stated that an excess return plus T-bills does not equate to the GSCI-TR because it ignores the impact of the reinvestment of T-bill collateral yield gains back into commodity futures and gains or losses from commodity futures back into or out of T-bills. An index constructed that solves this problem would permit a valid comparison between a theoretical Total Return and a Total Return index with the only difference reflected in costs of implementing the Total Return index strategy.

Costs typically incurred directly or indirectly such as transaction costs, fees, hedging costs and roll costs are ignored, the weighting method employed in the futures roll process is typically not compatible with matching assets and liabilities, and index weights require rebalancing.

ETF's are traditionally an index-based product that allows investors to buy or sell a single exchange-listed and traded security that is structured to represent an index portfolio or basket of stocks. ETF's typically seek to track generally the day-to-day movements in the value in the underlying assets such that the price of the security reflects the trust assets at any given time less the expenses and liabilities of the trust. The underlying stocks (or bond) assets are aggregated and placed via an in-kind trade into an approved structure. An ETF is a passive investment that trades as a listed security on a regulated exchange during the business day, that provide investors with the ability to gain investment exposure to the underlying assets to meet specific needs of investors. In contrast, most OTC funds only trade end-of-day, levy high management fees and have high transaction costs, lack transparency and suffer adverse tax effects particularly when actively traded.

A direct investment exposure to a foreign currency traditionally has been achieved by borrowing the currency, trading currency futures or OTC derivatives. Currencies typically also have well developed liquid forward currency markets.

Many investors however do not have a simple convenient way to access a direct investment exposure to foreign currencies

The ability of investors to access an investment exposure to the price of commodities and currencies in a simple, convenient, low cost, transparent way is extremely limited. There is a notable lack of ETF structured securities based on
commodity futures, (or non-commodity futures),
physicals or cash markets assets with a liquid forward paper contract market for an assets such as currencies or metals, that are able to be listed and traded on a regulated exchange under an ETF structure of continuous issuance and redemption on demand.

Additionally there are no EFT's based on a liquid forward paper contract market for an asset such as a currency. Traditional asset investments involve the full collateralisation of long asset purchases with a view to the asset appreciating in value and often with an associated positive yield. Investable securities based on indices (outline herein previously) have been structured as long only to emulate an investment in traditional financial assets such as stocks and bonds. This approach is limiting to investors as asset values can go down as well as up. There is a need for alternative investment assets that provide the opposite price risk exposure to long only traditional and commodity based investment securities. U.S. patent publication No. 2003/0154153 discloses a method of administering a commodity financial instrument by selecting a number of component financial products to form a composite commodity then forming a derivative product that can be traded up to a termination date. WO2004/006057 discloses a method of securitising a contract based on an index. An increase in the value of the contract supports issuing additional shares which may be redeemed. Purchase of shares involves both a cash payment and a futures contract.

It is an object of this invention to provide an investor with a cost effective and efficient way to invest in commodity through a structured investment security that it is able to be listed and traded on a regulated stock exchange or similar market.

### BRIEF DESCRIPTION OF THE INVENTION

Aspects of the present invention provide a computer program containing executable instructions for creating and managing an exchange traded, structured investment security which is based on an asset and is linked through its entitlement and reference price to the value or performance of the asset as measured against an index, the said asset having a forward price structure, a forward market, and an expiration date, in which the computer program is preloaded with data relating to said asset, the security price, reference price, entitlement, current and next market contract prices, trading day dates and weightings and said computer program uses the preloaded information to roll the asset forward and into another asset with a later expiry date and said program calculates the Security Price using the formula

S=R×E

where
S is the Security Price
R is the Reference Price
E is the value based Entitlement of the Security

In which the reference price is calculated by the formula

R=P₁W₁+P₂(1−W₁)
where
   R is the security Reference Price
   P₁ is the price of the Current Marker Contract C₁
   P₂ is the price of the Next Marker Contract C₂
   W₁ is the weight accorded to the Current Marker Contract C₁ at the completion of any calendar day, where
      0≦W₁≦1 for any calendar day that is a Roll Day
      W₁=1 for any calendar day that is a Non-Roll Day
         P₁ and P₂ are both market prices during the trading day or both end-of-day prices as the relevant circumstances require where the end-of-day price is the published price for the asset contract as determined in accordance with the rules, regulations and procedures of the relevant asset market and laws of the relevant jurisdiction in which entitlement is the claim on the number (including fraction thereof) on the underlying asset units or equivalent held per security that back each security, to which a security holder is entitled per security at redemption.

Aspects of the present invention enable the programmed computer system to create and manage a security and a corresponding index that may be based on an asset or derivative asset or a combination of these including but not limited to a commodity, a currency, or a basket or an index of any of these, that has a forward (or term) price structure, a forward contract market, an expiration date and can be rolled forward. The security is designed to meet the specific needs of investors and offer unique risk/return characteristics.

The security of this invention is linked directly to an index, and the index (and the security linked to it) are based on an underlying asset (or more than one as the case maybe), and the performance of the underlying asset is measured against the index. The underlying asset on which the security and its index are based has a market and the asset market of the underlying has a forward (or term) price structure, a forward contract market and an expiry date (and includes a maturity date or similar termination date).

The forward price structure of the underlying asset market may be in backwardation, contango, and from time to time in either backwardation or contango or neither.

According to aspects of the present invention, the computer program contains executable instructions that enable the underlying asset to be rolled over into new underlying asset with a later expiry date on a particular value basis wherein the claim of the security to the underlying assets held (that is the entitlement of the security) is calculated by taking into account the sum of that part of entitlement in respect of the first designated underlying asset not yet rolled plus that part of entitlement in respect of the next designated underlying asset rolled from the first designated underlying asset on the current roll day plus that part of entitlement in respect of the next designated underlying asset rolled from the first designated underlying asset on a roll day prior to the current roll day of the current roll period.

A change in entitlement may be calculated by the computer program of this invention is a consequence of either the rolling forward of underlying assets or a net adjustment factor or a combination of both.

Unlike prior art futures based securities and indices the computer program of this invention does not use a roll over process that is quantity based and does not acquire the same number of assets with a later expiry date, but rather acquires another asset of later expiry and of the same value. The value method embodied in the computer executable instructions of this invention differs from the prior art programs where components of a composite index were assigned a fixed percentage of the value of the index at inception and periodically rebalanced to maintain the fixed value of each component in the index. Such changes arose from relative performance of the index components or from the rolling forward of futures where the index has futures based components.

Unlike the prior art futures based securities and indices, the computer program in this invention creates instructions so that the proceeds raised from the disposal of the first designated underlying asset are automatically fully reinvested in acquiring the next designated underlying asset of later expiry.

The roll over of underlying assets on the value basis embodied in this invention removes the need for and does not require intervention in the form of index rebalancing. Unlike prior art, this invention provides executable instructions that enable the roll process to be flexibly performed in any proportion on any trading day and over such number of trading days desired compatible with the underlying asset market.

In the instance of a market disruption day, whether by limitation of price movement, unplanned market closure or other market impeding event, the executable instructions defer to the next non disrupted trading day, and contains instructions to adjust the roll proportions as desired or otherwise specified. The result of the executable instructions according to this invention is that the roll over of underlying assets on the value basis provides, per security or in aggregate an increase in the number of underlying assets when the forward price curve of the first underlying asset to the next designated underlying asset of later expiry is in backwardation and a decreasp when the forward price curve for same is in contango, and is reflected in an increase or decrease in the entitlement respectively. Accordingly, the investment risk exposure to the asset on which the security is based, increases, decreases or is unchanged due to backwardation, contango or flat forward price structures respectively.

According to the executable instructions of the computer program of aspects of this invention, a change in entitlement from the roll process itself does not change the security value. Rather, the roll incrementally replaces the underlying asset on which the index is calculated at the completion of each roll day with next designated underlying asset of later maturity. A change in the security value from the roll is derived, according to the algorithm utilized in this invention, from the subsequent change in price of the said asset convergence with the spot asset market of the newly acquired designated underlying asset of later expiry over time over time, such change in value referred to as the roll return.

In the algorithm of this invention, a change in entitlement is a consequence of a change in the net adjustment factor. A change in entitlement that results from the Net Adjustment factor changes the value (price) of the security. The net adjustment factor is predetermined and preloaded into the executable instructions and is designed to account for any debit or credit daily, periodically or one-off in respect of a security, its management and obligations, and is reflected as appropriate in the entitlement for each calendar day. Typically, a credit to the security is the collateral return (however characterized) and debits may include any costs, charges and expenses of any kind (notional or actual) such as management expenses and fees, transaction costs, hedging cost, regulatory and mandatory imposts including taxes and fees

The security generated by the program of this invention is designed to track the performance of a specified index, of an individual underlying asset, or of a basket of individual underlying assets of chosen proportions by replicating the composition of, or synthetically, the index or in any combination and structured in corresponding terms. This arrangement provides investors with exposure to particular risk/return characteristics of the underlying asset market without the need to operate directly in the underlying asset market itself.

The underlying assets or their equivalent are held to back the security and to match the liability of the securities on issue outstanding (as reasonably practicable to do so, typically rounded to the nearest limiting asset unit). The details of these assets are loaded into the data tables accessed by the computer program of this invention.

The security is preferably a fully collateralised (un-levered) long security comparable to an un-levered long position in an equity or bond.

In an alternate aspect, the security is a fully collateralised (un-levered) short security comparable in part only to an un-levered short position in an equity or bond. The security may be structured in the form of an equity based instrument, a debt based instrument, or as a hybrid of these and is redeemable for cash or may be redeemable in-kind. The long and the short security may be leveraged to gear investment returns. The security is preferably traded on a regulated exchange but may also be traded over-the-counter. The security is more preferably traded on a regulated exchange in an exchange traded fund (ETF) structure, typically able to be created or redeemed on demand on any trading day.

Unlike prior art for traditional stock or bond ETF's where creations typically involve in-kind transfer of assets, in a preferred aspect, creations and redemptions are for cash where the cash supports the acquisition of the underlying assets at creation and disposal of the underlying asset provides cash of equivalent value to the security holder at redemption.

Unlike prior art, in a preferred aspect, a security of this invention may be created and redeemed in accordance with a method and system for the creation and redemption of such a security under a particular exchange traded fund (ETF) structure described later herein.

In an alternative aspect, a security of this invention may be created and redeemed under one or more methods known to those skilled in the art. The security is preferably based on an exchange traded futures market contract and each futures contract month has a published settlement price on each typical trading day. It may be based on forward paper contracts for physicals of a physical (cash) market which can be cash settled for which there is or can be published a price assessment each typical trading day providing a valuation of that market, or a derivative on either of futures or physicals markets, swaps, or a combination of these for which a valuation assessment may be published each typical trading day. The data relating to the prices and movements in prices is accessed by the computer executable instructions contained in the program of this invention. The futures market contract is preferably any commodity based futures contract, including but not limited to: any energy futures such as for crude oil, heating oil, natural gas; any agricultural futures such as for corn, live cattle, coffee, cotton or soybean oil; any metal futures such as for copper or gold; other commodity futures. A currency based futures contract, or financial markets based futures contract may also be used.

Currency markets typically have well developed liquid forward paper contract markets. These foreign exchange contracts share similar characteristics to futures contracts:—a forward price structure, a forward market, an expiration date and is able to be rolled forward into another asset with a later expiry date wherein the asset is rolled into another asset with a later expiry date having the same value as the asset.

Unlike the prior art, the underlying asset of a currency based security of this invention is optionally a foreign currency forward paper contract, a currency futures, or a contractual obligation based on either of these. For a security based on futures, contractual obligation terms correspond to the terms of that security. For a security based on forward currency paper contracts, contractual obligation terms correspond to the terms of that security. The value based security VBS, preferably an ETF security, is designed to generate investment returns from investing preferably in commodities and currencies in leverage futures or futures style assets indirectly or synthetically plus a collateral return. The value based security (VBS) generated by the computer program of this invention is designed preferably to deliver a security actual total return (VBS-TR) that is directly comparable with a corresponding value based security total return index (VBSI-TR) and the value base security index (VBSI) flexibly constructed. VBS is preferably a fully collateralized security designed to generate investment returns equivalent to:
a rolling leveraged futures asset
PLUS a collateral yield
LESS costs.

Another aspect this invention provides a computer program containing executable instructions for creating and managing an index on which an exchange traded, structured investment security is based on the index tracking the price movements of the asset and is linked to the value or performance of the asset, the said asset having a forward price structure, a forward market, and an expiration date, in which the computer program is preloaded with data relating to said asset, reference price, entitlement, current and next marker contract prices, trading day dates and weightings and said computer program uses the preloaded information to roll the asset forward and into another asset with a later expiry date and said program calculates the index using the formula:

I=R×E

where
I is the index
R is the Reference Price
E is the value based Entitlement of the Security

In which the reference price is calculated by the formula

R=P₁W₁+P₂(1−W₁)
where
   R is the Reference Price
   P₁ is the price of the Current Marker Contract C₁
   P₂ is the price of the Next Marker Contract C₂
   W₁ is the weight accorded to the Current Marker Contract C at the completion of any calendar day, where
      0≦W₁≦1 for any calendar day that is a Roll Day
      W₁=1 for any calendar day that is a Non-Roll Day
         P₁ and P₂ are both market prices of the asset during the trading day or both end-of-day prices as the relevant circumstances require where the end-of-day price is the published price for the asset contract as determined in accordance with the rules, regulations and procedures of the relevant asset market and laws of the relevant jurisdiction in which entitlement is the notional claim on the underlying asset rolled forward.
         For a security based on rolling assets that expire (that inherently have different values) the value based approach herein provides for a security total return (VBS-TR) where:
there is full reinvestment in futures asset equivalents, embedded in the security, through the roll process thereby avoiding tails and underinvestment, and
investment daily of the collateral yield into the underlying asset futures equivalents,
   such that per security the collateral and the underlying futures equivalent assets are always equal to the value of the security, and the collateral yield less costs (net adjustment factor) results daily in an equivalent change in value of the underlying futures asset equivalents. The VBS-TR is equal to a theoretic VBSI-TR less costs. Unlike prior art, the VBS-TR consists of a price return and an entitlement return. The entitlement return consists of a roll return plus a net adjustment factor. The net adjustment factor consists of a collateral return less any costs.
   This invention provides the flexibility to custom design a VBSI consisting of one or more maturities of an individual underlying type of asset VBSI so defined, whether for an individual or composite VBSI can be matched and tracked by a correspondingly designed value based security (VBS).

The value of the security (reflected in its price) at any time is calculated by the computer program to be equal to the reference price multiplied by the entitlement that is a claim on the number of underlying asset units that back the security to which a security holder is entitled per security at redemption. A change in value of the security, as calculated by the algorithm used in the program of this invention, may result from a change in the reference price, or a change in the entitlement or both. A change in entitlement may result from the rolling forward of the underlying assets or a net adjustment factor (representing any debits or credit to the security) or either of these.

Uniquely and advantageously the computer program of this invention generates a short only, fully collateralised value based investment security that has unique investment return pay-offs, accesses a decrease in the underlying asset value and uniquely and advantageously has an associated positive collateral yield—unlike a short equity investment in a dividend paying stock that has an associated negative yield. A long only fully collateralised value based security that is borrowed and sold short is not equivalent to a VBS-Short security generated by the program of this invention where the collateral yield is paid to the lender and offset by interest received from shorting. Unlike a long only security where the price of the underlying asset and the security move in the same direction, a decrease in price of the index results in an increase in the security price.

The algorithm used in the computer executable instructions of this invention provides a particular value based method for the structuring of investment securities that are able to be exchange traded.
Base on futures, commodity or non-commodity, or cash markets with forward contracts (e.g. currencies), or contractual obligations with corresponding terms with securities based on either of these
A VBS and VBSI consist of a ‘price return’ plus an ‘entitlement’. VBS=Security Price=Reference Price*Entitlement that reflects the security structure
A VBS that is directly comparable with a corresponding value based theoretical total return index (VBSI-TR) flexibly constructed
The value based approach to structure securities (VBS-Value Based Securities)
The entitlement of the security
The creation and redemption of value based securities based on commodity futures and non-commodity based futures or cash market such as currencies with forward contracts in an ETF structure
VBS-Pairs—that is, un-levered, fully collateralised long (VBS-L) and short (VBS-S) securities—of complementary/opposite price risk exposure but collateral yield in common and more than one component part deriving from different individual underlying assets in any chosen proportions or maturities and in any combination of the component parts. Any VBSI so defined, whether for an individual or composite VBSI can be matched and tracked by a correspondingly designed value based security (VBS).

Advantageous characteristics for a structured exchange traded commodity investment security according to this invention include:
direct exposure to the commodity price without the having own the physical commodity or trade in futures;
security price tracks the commodity price;
accessible;
low minimum investment;
trades on a regulated exchange like an equity or other listed security
transparent;
low transaction fees;
ease of transacting, convenient;
negatively correlated with traditional asset classes;
created and redeemed on demand
able to be borrowed/lent-sold short
marginable, lendable

### DETAILED DESCRIPTION OF THE INVENTION

The drawings illustrate the structure and interactions in 4 embodiments of the computer network executable methods of this invention.

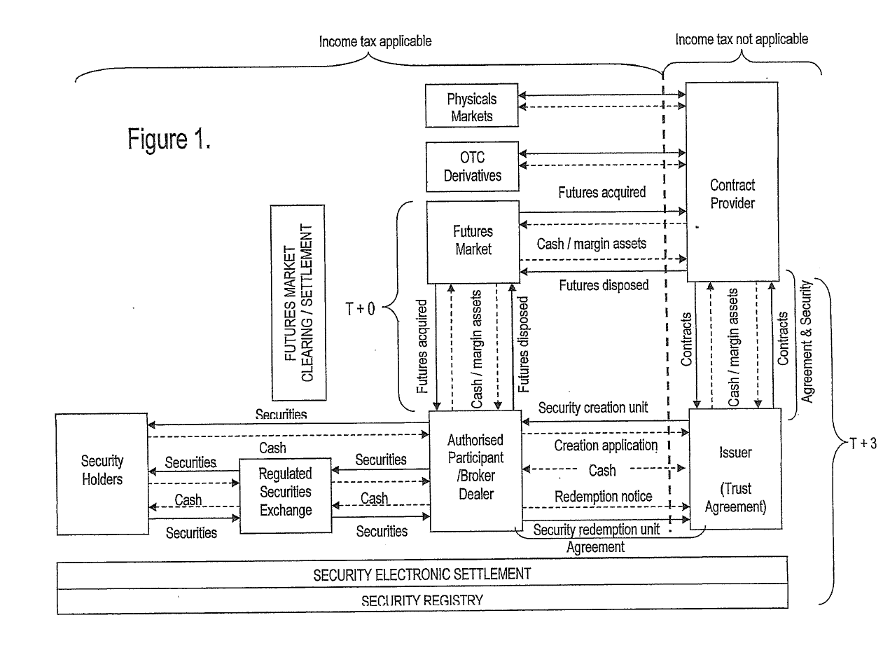

FIG. 1 illustrates the structure for a security of this invention in which the security is based on an index linked to futures and the underlying assets are contracts from a contract provider;

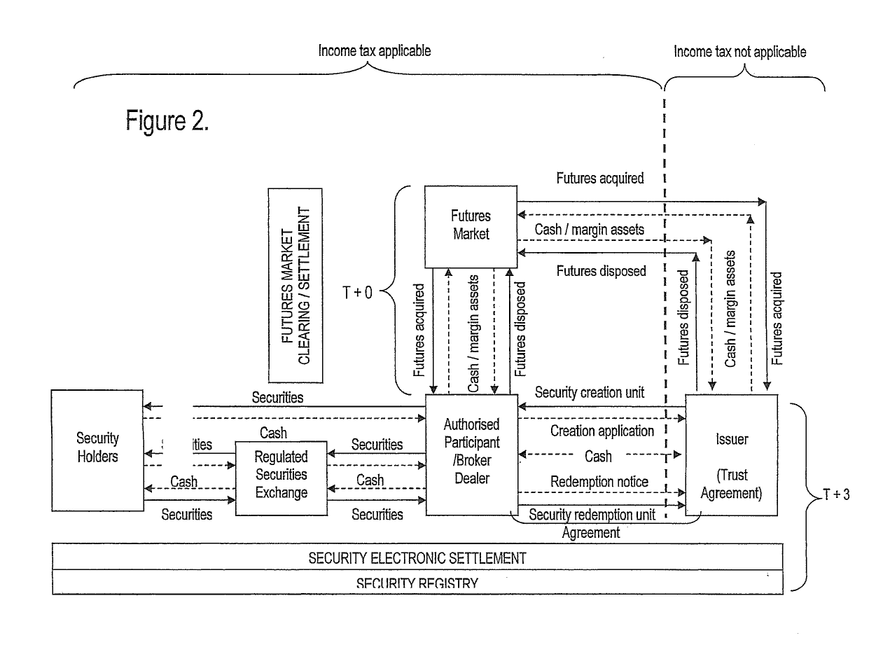

FIG. 2 illustrates the structure for a security of this invention in which the security is based on an index linked to futures and the underlying assets are futures contracts;

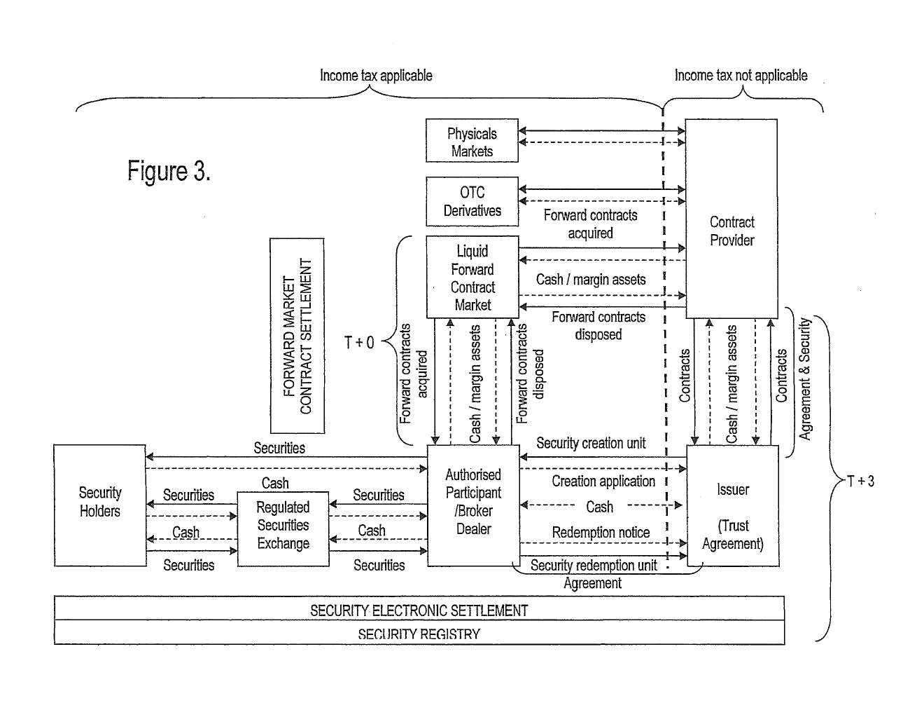

FIG. 3 illustrates the structure for a security of this invention in which the security is based on an index linked to liquid forward paper contract on an asset contract and the underlying assets are forward contracts from a contract provider;

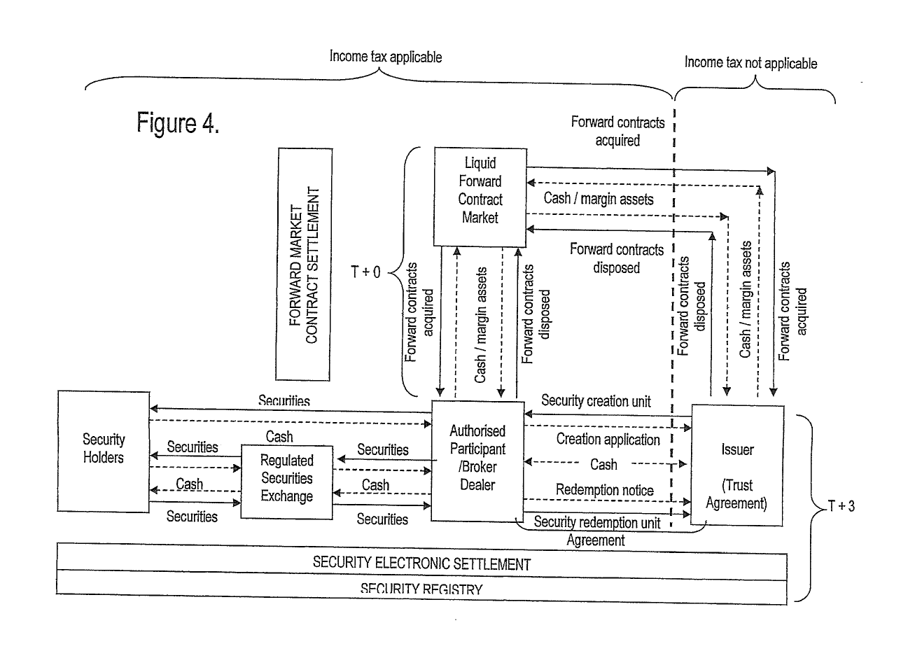

FIG. 4 illustrates the structure for a security of this invention in which the security is based on index linked to liquid forward paper contract on an asset contract and the underlying assets are forward contracts of the forward contract asset market.

FIG. 1 provides an overview of the entities and of the process flows in the creation, trading and redemption of the asset based security (oil futures) in the form of an ETF. FIG. 1 demonstrates a Security based on an index linked to futures and the underlying assets backing the security by Contracts. On any trading day the Issuer stands ready to, and can use the computer program to create Securities after receipt of a request from an Authorised Participant (and no other market participant), subject to conditions, on demand. Typically a request is in response to demand from investors and one or more authorised participants electronically communicates over a network, to use the computer program to generate to the Issuer a Creation Application Notice to create one or more blocks of the security or Creation Units priced in relation to the relevant futures contract settlement price to which the security is linked through an index.

In order to create the required securities, in the program of this embodiment, the Issuer executes instructions in the program that notifies a contract provider and the Contract Provider, of which there may be one or more, executes instructions in the program to generate contractual obligations under a Contract Agreement between the parties. The data tables accessed by the computer program contain contract obligations of a contract agreement have corresponding terms that match the security based on futures and similarly reflect entitlements. At any time the algorithm contained in the computer program ensures that value of a contractual obligation unit is equal to the value of the security. A contract agreement and the contractual obligations embedded therein are assets held by the Issuer that back the securities created and increase or decrease in number with security creations or redemptions and in value automatically correspond to an increase or decrease in the value of the security without requiring management intervention. These form part of the data stored in the data tables of the computer program. Another consequence of acquiring assets that have corresponding terms from the Contract Provider, is that the management of the roll forward of expiring assets in the roll process may be out sourced and is not required to be performed directly by the Issuer, which provides the advantage of reducing management and costs.

The authorised participant disaggregates the securities into smaller parcels that are placed directly with larger investors, or traded in the regulated exchange secondary market with investors, or held as unsold inventory. All market participants, other than authorised articipants, must acquire the securities from the secondary market of the regulated securities exchange.

Creations are for cash where the cash supports the acquisition of the underlying assets and disposal of the underlying assets provides cash of equivalent value to the security holder at redemption.

Security redemptions are initiated by an authorised participant providing a Redemption Notice to the Issuer requiring the redemption of securities, similarly to creations, in large blocks.

The ETF managed by the computer program of this invention is designed with a specific objective to minimize the effects of taxation on investment assets. In an unfavourable taxation environment, assets such as futures that are required to be rolled forward and replaced with similar asset of later expiry under an unfavourable taxation structure, results in the diminution of investment assets and consequently inefficiency and underperformance. Accordingly the Issuer, a company whose purpose is to issue the Security and hold assets on trust, is constituted to minimise the effect of an unfavourable taxation environment because of the negative impact on investment assets held, particularly from the rolling forward of expiring assets and correspondingly the value of the Security.

The terms and conditions of the Securities are established according to a trust agreement between the Issuer and the Trustee. The holders of Securities are recourse limited to the extent of the net assets held on trust. The Trustee is similarly recourse limited. Dependent on the specification of the security optionally all, some or none of the daily interest earned on the collateral funds may accrue to the value of the security and optionally change with notice.

In an alternative aspect, the Issuer is a Trust where the security holders can be considered grantors of the trust. A trust constituted under sections 671-677 of the United States Internal Revenue Code 1986 as amended is such a trust. Optionally to the futures settlement price used by way of the Reference Price in pricing the Security, a futures price of the trading range of the trading day of the creation application may alternatively conditionally be used.

Securities created or redeemed are settled by electronic settlement that effects delivery of security holdings certificates against cash and the electronic holdings are maintained by a security registry service optionally with the security creation alternative payment conditions may be permitted.

FIG. 2 differs from FIG. 1 in that it illustrates a Security based on an index linked to futures and the underlying assets backing the security are futures contracts. In a security creation, the authorised participant who uses the computer program to generate a Creation Application to the Issuer, procures futures contracts that are transferred to the Issuer by way of known ‘exchange for asset’ (eg EFP's and EFS) procedure where by futures are received by the Issuer and corresponding Creation Unit(s) are delivered by the Issuer to the authorised participant at settlement typically after 3 business days. Optionally, the Issuer procures the futures contracts directly.

FIG. 3 illustrates a Security based on an index linked to a liquid forward contract market on an asset such as a currency and the underlying assets backing the security are Contracts from a contract provider based on the forward contract asset market (currency).

FIG. 4 illustrates a Security based on an index linked to a liquid forward contract market of an asset such as a currency and the underlying assets backing the security are forward paper contracts of the asset market procured by the Authorised Participant who generates a Creation Application to the Issuer, or optionally by the Issuer directly.

A preferred aspect of the computer executable instructions of this invention will now be described detailing the method of automatically managing the pricing, valuing and trading of the security by providing an algorithm for calculating the entitlement on a value basis when rolling one underlying asset backing the security into one with a later expiry date, and a method for creation and redemption of the security.

A specific example of a long security according to this invention is one based on an oil futures and which can be exchange traded Security and Index. The structured exchange traded commodity (or non-commodity) investment security generated by the program of this invention is a value based security (VBS) which is based on and directly linked to the performance of an underlying asset (for this example crude oil futures) through price and entitlement. The performance of the underlying assets and their linked VBS are measured against an index, in this example, oil futures, and the index value is calculated by the algorithm at any time based on the reference price.

The security, constructed with the value based approach, in this example, is designed to provide and results in unique total return notional and actual outcomes. The value based security total return, VBS-TR, consists of a price return (represented by reference price) and an entitlement return. The entitlement return consists of a roll return plus a net adjustment factor. The net adjustment factor consists of a collateral return less any costs.

The algorithm used in the program of this invention provides the flexibility to custom design VBSI's in asset composition, proportions and maturities. Examples of indices are a single asset type based only on the nearby maturity futures contract (eg crude oil nearby futures contract described below), an index for a single asset type based on more than one maturity (eg an index consisting of the first four crude oil futures contracts weighted 40%, 30%, 20%, 10%), or an index consisting of more than one asset type but similar maturity (eg a composite index of crude oil, corn and copper, each of nearby futures contracts or alternatively differing maturity). VBSI so defined, whether for an individual or composite index, can be matched and tracked by a correspondingly designed value based security (VBS).

### Security Price

For each Security, the Security Price as used in the algorithm is equal to the Reference Price multiplied by the Entitlement of the Security, and expressed in the form

S=R×E

where
S is the Security Price
R is the Reference Price (defined below)
E is the Entitlement of the Security (defined below)

### Investment Return

The investment return calculated by the algorithm for each Security consists of:
a change (increase or decrease) in the Reference Price R constructed to track the relevant underlying asset market, and
a change in Entitlement

### Marker Contract

A Marker Contract is a futures contract (in this example a commodity futures contract for crude oil) that is
an underlying assets on which the Security is based.
designated to be used in the calculation of the Reference Price
   A Marker Contract price that is used to calculate the Reference Price is a market price or the settlement price (as the relevant circumstances require)
   The nearest designated Marker Contract is the Current Marker Contract C₁ of price P₁ and is usually but not always the spot futures contract.
   The contract designated to follow the Current Marker Contract is the Next Marker Contract C₂ of price P₂ and is usually but not always sequentially the next futures contract.

The Next Marker Contract incrementally becomes the Current Marker Contract for the next trading day after completion of each day of the Roll (defined below)

For the purposes of this exposition of the method the Marker contracts are Current and Next, but is not limiting on the number of futures contract months (and therefore the number of Marker Contracts) that are underlying assets on which the security is based (and on which the Reference Price is calculated) with the method modified accordingly.

### The Reference Price

The security Reference Price R as used in the algorithm is designed to track the price of the underlying assets on which the security is based.
The Reference Price of the Security in this example (based on a single asset index—oil futures) on any trading day is calculated in the program as a simple weighted average of the price P₁ of the Current Marker Contract C₁ multiplied by the relevant weight W₁, and the price P₂ of the Next Marker Contract C₂ multiplied by the relevant weight 1−W₁, and expressed in the form

R=P₁W₁+P₂(1−W₁)

where
R is the security Reference Price
P₁ is the price of the Current Marker Contract C₁
P₂ is the price of the Next Marker Contract C₂
W₁ is the weight accorded to the Current Marker Contract C₁ at the completion of any calendar day, where
   0≦W₁≦1 for any calendar day that is a Roll Day
      W₁=1 for any calendar day that is a Non-Roll Day
P₁ and P₂ are both market prices of the same time frame during the trading day or both Settlement Prices as the relevant circumstances require where the Settlement Price is the end-of-day price of a futures contract as determined in accordance with the rules, regulations and procedures of the relevant futures exchange and laws of the relevant jurisdiction.
   For any trading day that is a Non-Roll Day outside of the Roll period the Reference Price R is the Current Marker Contract price P₁, that is

R=P₁

### The Roll

The Roll is a process carried out by the program where the underlying assets in the form of the Current Marker Contracts are replaced by the acquired Next Marker Contracts.
The Roll is performed for one or more trading days up to the maximum number of trading days as there exists between the designated Marker Contracts between which the Roll is to be performed

where
Roll Day is a day r on which the Roll process is performed, (where r is an integer>0)
Non-Roll Day is any day r that is not a Roll Day, where r=0
trading day is any day, that is not a public holiday, bank holiday, weekend or, market Disruption Day, on which the relevant Exchange(s) or market(s) for the Security and the underlying asset market are open for and able to transact business without Disruption.
calendar day is any day of the year, c

### Value Based Roll

The method used by the computer program in the Roll process is a ‘value’ based approach not a ‘quantity’ based approach as in prior art roll over of futures.
The ‘value’ based method provides that:
the value of the underlying assets that back the Security (or securities in aggregate) always matches the liability of the Security (or securities on issue outstanding
on each roll day the ‘value’ (not number) of Current Marker Contracts C₁ disposed of must be replaced by the Acquisition of Next Marker Contracts C₂ of equal ‘value’ (not number)
the price ratio (P₁/P₂), the value equator of the Current and Next Marker Contracts is used to determine the number of Next Marker Contracts to acquire that are equal in value to the Current Marker contracts disposed of, (number of C₂ to buy=number of C₁ sold×price ratio (P₁/P₂)
the price ratio (P₁/P₂) reflects the investment return, that accrues over time to investors attributable to the forward price structure of the underlying asset (P₁>P₂-backwardation, P₁<P₂-contango, P₁=P₂-flat) and the Rolling forward of the underlying assets (futures) and is captured in the Entitlement of the Security. (defined below)
the change in the number of futures contracts represents a change in the number of futures contracts (or fraction thereof) backing each Security and in the claim to which a holder of the Security is entitled on redemption, that is, Entitlement
the value of the futures contracts that back each Security matches the liability of the Security on issue outstanding, rounded to the nearest contract,
investors gain exposure to the underlying asset whose investment risk exposure is sought and that the underlying asset match that risk exposure at all times to the full extent of the Security value. This eliminates tails and under investment in the asset risk exposure sought that would otherwise result under a ‘quantity’ based approach due to the mismatch of proceeds from disposal of the Current marker contract and the funds required to acquire the Next marker Contract of equal quantity (number)
   In contrast to the ‘value’ based approach, the ‘quantity’ base approach provides that:
a Security equals a set quantity (number or units) of the underlying asset—for example 1 barrel of oil or a set number of barrels of oil
the rolling forward of the futures contracts from the Current to the Next Marker contract is performed by disposing of a specified ‘number’ (quantity) of Current Marker Contracts and replacing them by acquiring the same ‘number’ (quantity) of Next Marker Contracts}
   The quantity based approach has particular problems and deficiencies in the context of the Security and ETF structure that the method according to this invention solves. One example of this problem is where a market is in backwardation (where P₁>P₂). The dollar amount generated by the disposal of a specified quantity of Current Marker Contract C₁ at price P₁ is greater than the dollar amount required to acquire a Next designated Marker Contract C₂ at P₂ of equal quantity resulting a cash tail (at that time and thereafter) and results in less than full investment risk exposure to the underlying assets. Per Security, the Security Price (value) is greater than the value of underlying asset. This results in an under investment (per Security) in the underlying risk assets backing the Security and a mismatch with the value of the Security
   Another example of the problem with quantity based roll over is where a market is in contango (where P₁<P₂) and a quantity (number) mismatching problem arises. The dollar amount generated by the sale of each marker futures contract C₁ at price P₁ is not sufficient to purchase the same quantity (number) of futures contract C₂ at P₂ to maintain a fix quantity to Security relationship.

### Entitlement

Entitlement as calculated in the algorithm used in the program of this invention is the claim on the number (including fraction thereof) on the underlying asset units or equivalent held per security that back each Security, to which a Security holder is entitled per Security at redemption in cash (or in kind according to the context).
A change in Entitlement reflects a change in the claim per security on the number (including fraction thereof), of underlying asset units or equivalent held that back each Security.
Similarly, on a whole of fund (total Securities outstanding) basis, Entitlement in aggregate reflects the number of underlying asset units that back the Securities outstanding.
Changes in Entitlement may result from
the Rolling forward of the underlying assets (futures contracts) where the value difference between Marker Contracts C₁ & C₂ is captured in the price ratio (P₁/P₂) on each Roll Day and reflected in a change in Entitlement
a Net Adjustment Factor F which is calculated as the Net of
   credits or benefits of any kind (typically expressed as a percentage)
      and
   debits of any kind (typically expressed as a percentage) and,
   in any combination, timing, order or otherwise as the relevant circumstances require
      The Net Adjustment Factor F as used in the algorithm of this invention is designed to account for any debit or credit (accrued or charged, paid or payable as the case may be and in accordance with the relevant circumstance), and to be reflected as appropriate in the Entitlement for each calendar day.
      The Net Adjustment Factor F is calculated as one (1) minus the Net of
debits of any kind (typically expressed as a percentage) including any costs, charges and expenses of any kind (notional or actual) such as management expenses and fees, transaction costs, hedging cost, regulatory and mandatory imposts including taxes and fees accruing or charged daily periodically or one-off as the case may be that may be debited against the security and its underlying assets or any combination of these,
minus
credits or benefits of any kind (notional or actual typically expressed as a percentage) accruing or credited daily, periodically or one-off typically the collateral return how ever characterized in such forms as interest, dividends, bonuses or other credit or benefit or any combination of these,
and
if a circumstance requires application in a particular order, then in an order so required
where
   F=(1−f %) and
   f % is the percentage per annum rate for any debits minus the percentage per annum rate for any credits (applied as the relevant circumstances require)
      To the extent that any debit or credit (or the Net thereof) is lumpy, is focused on a particular point or points in time, the relative size of such debits or credits or the net thereof may induce arbitrage activities that distort the secondary market price of the Security in expectation of such debits or credits being made. This type of market behavior is common in financial markets with market participants pricing in, for example, expected or actual payment of a share dividend or bond coupon (as relevant to the type of security). It may therefore be preferred to the extent that it is practical and reasonable to do so, to spread the component parts of the Net Adjustment factor over a period of time. For example, the deduction of a per annum management fee or accrue interest on a daily basis across the course of the year would be reflected as incremental daily changes in Entitlement and accordingly in the security value and the underlying assets. For a debit the equivalent value in futures contracts (underlying asset) is removed from the net assets of the fund. For a credit the equivalent value in futures contracts (underlying asset) is added to the net assets of the fund.

### Disruption Day

A market Disruption Day is a trading day in respect of the underlying asset where the price of the underlying asset is not published or market trading is disrupted by limitation of price movement, unplanned market closure or other market impeding event. In the event of a Disruption Day the roll process program defers to the next non disrupted trading day and the roll proportions adjusted as desired or otherwise specified.
Relationship between Security Price, Reference Price, the Underlying Assets and Entitlement
In the method and algorithm used in this invention the Security Price is directly linked to the Reference Price which is directly linked to the value of the underlying assets (oil futures) which back the Security. By way of illustration, a 1% change in the value of the underlying assets results in a 1% change in the Reference Price and similarly a 1% change in the Security Price.

### Per Security

Security Price S=Reference Price R×Entitlement E=Value of Underlying Assets

Therefore,

Entitlement E=Security Price S/Reference Price R

and

Entitlement E=Value of Underlying Assets/Reference Price R

### Entitlement Characteristics

Entitlement may be calculated in the algorithm used in this invention under a number of closely related quantitative forms which vary in construction, definitions and constraints. In general each form
recognizes that entitlement calculated for a particular day is a function of entitlement for a prior day
may differ in respect of which particular day or days (and these vary and overlap in definition between the various forms) it refers (for example—a calendar, Roll, Non Roll, Trading or Non Trading day) in its computation to arrive at a value of entitlement for a security on a particular day
explicitly (calendar day basis) or both explicitly and implicitly (Trading day basis) calculates Entitlement for each day of the year.
for a day on which entitlement for each form can be calculated, each form will give the same entitlement value of the security
is value based as represented in this invention and accordingly includes value based ratio weights
incorporates a Net Adjustment Factor (or equivalent) but may differ in the manner of its incorporation. For example it may be applied as a single number independent of an Entitlement ratio based form or embedded in the weights associated with the element of Entitlement in respect of each Marker Contract that sum to Entitlement.
maintains the identity of Asset=Liabilities automatically without the need for rebalancing
provides the flexibility for the amount (proportion) rolled on a Roll Day to vary from the proportion rolled on another Roll Day of the Roll period, or for the proportion rolled each day to be in equal proportions
provides the flexibility to accommodate market Disruption Days.

### Entitlement Quantitative Forms

Four variations of the entitlement calculation as used in the algorithms used in the computer programs of this invention are presented, two under each of two general forms. Variations of the Entitlement formulations provided, including but not limited to such things as variations in construction, specified criteria, definitions and constraints obvious to one skilled in the art are variations of the invention.

### Entitlement—Variation (A)

Entitlement calculated for any calendar day that is a Non Roll Day outside or within a Roll period, or that is a Roll Day of a Roll period.

### Derivation of Entitlement

The following derivation is provided for Entitlement on a calendar day basis firstly without and then with the incorporation of a Net Adjustment Factor for a Non Roll Day outside or within a Roll period, and for a Roll Day of a Roll period, resulting in added complexity.

### Entitlement for a Non-Roll Day

For any calendar day c that is a Non-Roll Day r and there is no Net Adjustment Factor to be accounted for, Entitlement is equal to the previous calendar day's Entitlement and expressed quantitatively in the form

E_{(c)}=E_{(c-1)}

and
for any calendar day c that is a Non-Roll day r and there is a Net Adjustment Factor to be accounted for, Entitlement is equal to the previous calendar day's Entitlement multiplied by the Net Adjustment Factor F and expressed quantitatively in the form

E_{(c)}=E_{(c-1)}×F

where
E_{(c)} is Entitlement for a calendar day c for a Non-Roll Day in respect of r where r=0
E_{(c-1)} is the Entitlement on the calendar day prior to calendar day c
c is a calendar day to which there is a corresponding r
F is the Net Adjustment Factor
   Entitlement for a Roll Day of a single Roll period with no Net Adjustment Factor At the completion of each Roll Day r:
the proportion (or number representing the proportion) of C₁ contracts (underlying assets) is the Un-Rolled amount (ie. the amount not yet Rolled). This Un-Rolled amount can be equally defined by its complement, that is, 1 minus the sum of the proportion of C₁ contracts Rolled on the current Roll Day and each prior Roll Day of a Roll period
the proportion (number) of C₂ contracts is an amount equal to the sum of the proportion of C₁ contracts Rolled on the current and prior Roll Days of a Roll period multiplied by the Price Ratio P₁₍ᵣ₎/P₂₍ᵣ₎ applicable for the relevant Roll Day r,
the value of C₁ and C₂ contracts at the completion of any Roll Day r is calculated by multiplying
   the number (corresponding to the proportion) of Un-Rolled C₁ contracts (consisting of units per contract for example 1000 barrels per oil futures contract) multiplied by price P₁,
plus
   the number (corresponding to the proportion) of C₂ contracts (consisting of units per contract) resulting from the Roll multiplied by price P₂
      The proportion (number) of C₁ contracts Rolled on each Roll Day r may be weighted equally or may vary (not be equally weighted) and is represented by J₁₍ᵣ₎.
      Per Security at the completion of each day r
the proportion (number) of C₂ contracts is
   W₁₍ᵣ₎
where
   W₁₍ᵣ₎=1−ΣJ₁₍ₙ₎ Σ has a range n=1 to r
   and ΣJ₁₍ₙ₎=1 Σ has a range n=1 to d
the proportion (number) of C₂ contracts is
   W^{$}₍ᵣ₎
where
   W^{$}₍ᵣ₎=Σ{J₍ₙ₎×(P₁₍ₙ₎/P₂₍ₙ₎)} Σ has a range n=1 to r,
   and ΣJ₁₍ₙ₎=1 Σ has a range n=1 to d
the value of the C₁ contracts is:

P₁₍ᵣ₎×W₁₍ᵣ₎
the value of the C₂ contracts is

P₂(r)×W^{$}₍ᵣ₎
where
   C₁ is the Current Marker Contract
   C₂ is the Next Marker Contract
   P₁₍ᵣ₎ is the price of the Current Marker Contract C₁ on day r
   P₂₍ᵣ₎ is the price of the Next Marker Contract C₂ on day r
   W₁₍ᵣ₎ is the weight (proportion) accorded to the Current Marker Contract C₁ reflecting C₁ not yet rolled at the completion of day r, where
      W₁₍ᵣ₎=1−ΣJ₁₍ₙ₎ has a range, n=1 to r in the Roll period
         W₁₍ᵣ₎=1 for a Non-Roll Day r=0 outside the period Roll,
         W₁₍ᵣ₋₁₎ is the weight for the immediate day prior
   J₁₍ᵣ₎ is the weight (proportion) of C₁ Rolled on a day r, where
      ΣJ₁₍ₙ₎=1 Σ has a range n=1 to d and
      J₁₍ᵣ₎=1/d only where the amount Rolled is equally weighted during the Roll for each day r
      W₁₍ᵣ₎ may also be expressed in various forms for an equally weighted Roll including,

W₁₍ᵣ₎=(d−r)/d or 1−(r/d) or 1−Σ(1/d)
where Σ has a range n=1 to r
d is the total number of Roll Days on which the Roll takes place
r for a Roll Day r, is greater than 0 (zero), has integer values of 1 through d that correspond to the number of the Roll Day, there is a corresponding calendar day c referring to the same day
   and,
   for a Non-Roll Day r, has a value of 0 (zero), there is a corresponding calendar day c referring to the same day
n is an integer counter
W^{$}₍ᵣ₎ is the weight that equates the value of C₁ sold to the value of C₂ bought in the Roll process at the completion of each day r, and W^{$}_{(r)=Σ{J}₁₍ₙ₎×(P₁₍ₙ₎/P₂₍ₙ₎)} Σ has a range n=0 to r
R₍ᵣ₎ is the Reference Price on day r
E is Entitlement for day r
c is a calendar day to which there is a corresponding r

### Since

Entitlement=Value of Underlying Asset/Reference Price

then
Entitlement for each Roll Day r for a Roll period (with no Net Adjustment Factor) is calculated as follows:

### Roll Day 1

E₍₁₎={(P₁₍₁₎×(1−J₁₍₁₎))+(P₂₍₁₎×J₁₍₁₎×(P₁₍₁₎/P₂₍₁₎))}/{(P₁₍₁₎×(1−J₁₍₁₎))+(P₂₍₁₎×(J₁₍₁₎)}

### Roll Day 2

E₍₂₎={(P₁₍₂₎×(1−(J₁₍₁₎+J₁₍₂₎))+(P₂₍₂₎×(J₁₍₁₎×(P₁₍₁₎/P₂₍₁₎))+(J₁₍₂₎×(P₁₍₂₎/P₂₍₂₎)))}/{(P₁₍₂₎×(1−(J₁₍₁₎+J₁₍₂₎))+(P₂₍₂₎×(J₁₍₁₎+J₁₍₂₎))}

and so forth to the completion of d Roll Days.
Entitlement for a single Roll period can be expressed quantitatively in a more general form such that the completion of each Day of the Roll

E₍ᵣ₎={(P₁₍ᵣ₎×(1−ΣJ₁₍ᵣ₎))+(P₂₍ᵣ₎×Σ(J₁₍ᵣ₎×(P₁₍ᵣ₎/P₂₍ᵣ₎)))}/{(P₁₍ᵣ₎×1−J₁₍ᵣ₎)+(P₂₍ᵣ₎×(J₁₍ᵣ₎)}

Or

E₍ᵣ₎={P₁₍ᵣ₎×W₁₍ᵣ₎+P₂₍ᵣ₎×W^{$}₍ᵣ₎}/R₍ᵣ₎

The expression for Entitlement in this form is limited to the calculation of Entitlement for a single isolated Roll period, does not provide a link to an Entitlement value of a Non Roll Day prior to or within the Roll, or accommodate a Net Adjustment Factor F. A construction of

E₍ᵣ₎=E₍ᵣ₋₁₎×{(P₁₍ᵣ₎×W₁₍ᵣ₎)+(P₂₍ᵣ₎×W^{$}₍ᵣ₎)/R₍ᵣ₎}×F

does not yield Entitlement values that maintain the identity of Assets equals Liabilities except for the first calculation day.
Linking Entitlement for a calendar day that is a Roll Day (r) to the prior Roll Day (r−1)

### Since

E₍ᵣ₎{P₁₍ᵣ₎×W₁₍ᵣ₎+P₂₍ᵣ₎×W^{$}₍ᵣ₎}/R₍ᵣ₎ (equation 1)

and for an immediately prior day that is a Roll Day

E₍ᵣ₋₁₎={P₁₍ᵣ₋₁₎×W₁₍ᵣ₋₁₎+P₂₍ᵣ₋₁₎×W^{$}₍ᵣ₋₁₎}/R₍ᵣ₋₁₎ (equation 2)

Dividing equation 1 by equation 2, rearranging, and incorporating the Net Adjustment Factor, Entitlement is expressed quantitatively in the form:

E₍ᵣ₎=E₍ᵣ₋₁₎×[{P₁₍ᵣ₎×W₁₍ᵣ₎+P₂₍ᵣ₎×W^{$}₍ᵣ₎}/R₍ᵣ₎]/[{P₁₍ᵣ₋₁₎×W₁₍ᵣ₋₁₎+P₂₍ᵣ₋₁₎×W^{$}₍ᵣ₋₁₎}/R₍ᵣ₋₁₎]×F

In more general form on a calendar day basis
For any calendar day c that is a Roll day r (except a Disruption Day) and there is a Net Adjustment Factor to be accounted for, Entitlement is equal to the previous calendar day's Entitlement multiplied by a value based entitlement ratio of the current and the prior Roll Days multiplied by the Net Adjustment Factor F, is expressed quantitatively in the form

E_{(c)}=E_{(c-1)}×[{P₁₍ᵣ₎×W₁₍ᵣ₎+P₂₍ᵣ₎×W^{$}₍ᵣ₎}/R₍ᵣ₎]/[{P₁₍ᵣ₋₁₎×W₁₍ᵣ₋₁₎+P₂₍ᵣ₋₁₎×W^{$}₍ᵣ₋₁₎}/R₍ᵣ₋₁₎]×F

and (restating from above),
for any calendar day c that is a Non-Roll day r and there is a Net Adjustment Factor to be accounted for, Entitlement is equal to the previous calendar day's Entitlement multiplied by the Net Adjustment Factor F and expressed quantitatively in the form

E_{(c)}=E_{(c-1)}×F

where
E_{(c)} is Entitlement for a calendar day c for any Non-Roll Day r where r=0
E_{(c-1)} is the Entitlement on the calendar day immediately prior to calendar day c
c is a calendar day to which there is a corresponding r
F is the Net Adjustment Factor
P₁₍ᵣ₎ is the price of the Current Marker Contract C₁ on day r
P₂(r) is the price of the Next Marker Contract C₂ on day r
W₁₍ᵣ₎ is the weight (proportion) accorded to the Current Marker Contract C₁ reflecting C₁ not yet rolled at the completion of day r, where
   W₁₍ᵣ₎=1−ΣJ₁₍ₙ₎ Σ has a range, n=1 to r in the Roll period
      W₁₍ᵣ₎=1 for a Non-Roll Day r=0 outside the period Roll,
   W₁₍ᵣ₋₁₎ in the Roll is the weight of the prior Roll Day
J₁₍ᵣ₎ is the weight (proportion) of C₁ Rolled on a day r, where
   ΣJ₁₍ₙ₎=1 Σ has a range n=1 to d and
   J₁₍ᵣ₎=1/d only where the amount Rolled is equally weighted during the Roll for each day r
d is the total number of Roll Days on which the Roll takes place
r for a Roll Day r, is greater than 0 (zero), has integer values of 1 through d that correspond to the number of the Roll Day, there is a corresponding calendar day c referring to the same day and,
   for a Non-Roll Day r, has a value of 0 (zero), there is a corresponding calendar day c referring to the same day
n is an integer counter
W^{$}₍ᵣ₎ is the weight that equates the value of C₁ sold to the value of C₂ bought in the Roll process at the completion of each Roll Day r, and
   W^{$}₍ᵣ₎=Σ{J₁₍ₙ₎×(P₁₍ₙ₎/P₂₍ₙ₎)} Σ has a range n=0 to r
R₍ᵣ₎ is the Reference Price on day r
   Defining Entitlement for any calendar day in Single Expression
   If for any day other than a Roll Day

P₁₍ᵣ₎×W₁₍ᵣ₎+P₂₍ᵣ₎×W^{$}₍ᵣ₎}/R₍ᵣ₎]/[{P₁₍ᵣ₋₁₎×W₁₍ᵣ₋₁₎+P₂₍ᵣ₋₁₎×W^{$}₍ᵣ₋₁₎}/R₍ᵣ₋₁₎]

is defined to equal one (1), then Entitlement for any calendar day may be expressed quantitatively in the form of a single expression

E_{(c)}=E_{(c-1)}×[{P₁₍ᵣ₎×W₁₍ᵣ₎+P₂₍ᵣ₎×W^{$}₍ᵣ₎}/R₍ᵣ₎][{P₁₍ᵣ₋₁₎×W₁₍ᵣ₋₁₎+P₂₍ᵣ₋₁₎×W^{$}₍ᵣ₋₁₎}/R₍ᵣ₋₁₎]×F

### Entitlement—Variation (B)

### Entitlement Calculated for any Trading Day

An alternative variation provides for Entitlement to be calculated for any trading day within and outside the Roll period using the same general structure as Entitlement for a calendar day in variation A.

Entitlement E₍ₜ₎ for a trading day t outside a Roll period (that is not a Disruption Day) is

E₍ₜ₎=E₍ₜ₋₁₎×F^{(m)}

where
E₍ₜ₎ is Entitlement for a trading day t
E₍ₜ₋₁₎ is Entitlement on the trading day prior to trading day t
t is a trading day that is not a Disruption Day
F is the Net Adjustment Factor
m is an integer counter in respect of F that is the number of days equal to the current trading day plus the number of non trading days since the prior trading day where F^{(m)}
   Entitlement E₍ₜ₎ for a trading Day (that is not a Disruption Day) that is a Roll Day and there is a Net Adjustment Factor to be accounted for is equal to the previous trading day's Entitlement multiplied by a value based entitlement ratio of the current day and prior trading day multiplied by the Net Adjustment Factor F (accounting for the number of days since the prior trading day including the current trading day) and is expressed as

E₍ₜ₎=E₍ₜ₋₁₎×[{P₁₍ᵣ₎×W₁₍ᵣ₎+P₂₍ᵣ₎×W^{$}₍ᵣ₎}/R₍ₜ₎][{P₁₍ᵣ₋₁₎×W₁₍ᵣ₋₁₎+P₂₍ᵣ₋₁₎×W^{$}₍ᵣ₋₁₎}/R₍ₜ₋₁₎]×F^{(m)}

where
E₍ₜ₎ is Entitlement on a trading day t in respect of a Roll day r
E₍ₜ₋₁₎ is Entitlement on the trading day prior to trading day t
t is a trading day to which there is a corresponding r and is not a Disruption Day
F is the Net Adjustment Factor
m is an integer counter in respect of F that is the number of days equal to the current trading day plus the number of non trading days since the prior trading day where F^{(m)}
P₁₍ᵣ₎ is the price of the Current Marker Contract C₁ on trading day t
P₂(r) is the price of the Next Marker Contract C₂ on trading day t
W₁₍ᵣ₎ is the weight (proportion) accorded to the Current Marker Contract C₁ reflecting C₁ not yet rolled at the completion of trading day t that is a Roll day r, where
   W₁₍ᵣ₎=ΣJ₁₍ₙ₎Σ has a range, n=1 to r in the Roll period
      W₁₍ᵣ₌₀₎=1 for a trading day outside the Roll period
   W₁₍ᵣ₋₁₎ is the weight for the prior trading day
J₁₍ᵣ₎ is the weight (proportion) of C₁ Rolled on a day r, where
   ΣJ₁₍ₙ₎=1 Σ has a range n=1 to d and
   ΣJ₁₍ᵣ₎=1/d only where the amount Rolled is equally weighted during the Roll for each day r
d is the total number of Roll Days on which the Roll takes place
r for a Roll Day r, is greater than 0 (zero), has integer values of 1 through d that correspond to the number of the Roll Day, there is a corresponding Trading day t referring to the same day and,
   for a Non-Roll Day r, has a value of 0 (zero), there is a corresponding Trading day t referring to the same day
n is an integer counter
W^{$}₍ᵣ₎ is the weight that equates the value of C₁ disposed to the value of C₂ acquired in the Roll process at the completion of each Roll day r, and
   W^{$}₍ᵣ₎=Σ{J₁₍ₙ₎×(P₁₍ₙ₎/P₂₍ₙ₎)} Σ has a range n=0 to r
R₍ₜ₎ is the Reference Price on trading day t
   If the net adjustment factor F for days (non trading and trading) accounted for by m in F^{(m)} is the same for each such day, then by way of illustration, on a Monday trading day following a weekend where interest accrued and management fees charged are the same for each day (that is F is the same for calendar days—Saturday, Sunday, Monday), then

F^{(m)}=F³.

If the net adjustment factor for such days differ from each other, for example an additional one-off fee or expense was charged on the Monday, then F^{(m)} is disaggregated into its component parts applicable for each calendar day such that

F^{(m)}=F_{(c)}×F_{(c-1)}×F_{(c-2)}.

Entitlement for a trading day differs from Variation (A) in that entitlement is calculated only on a trading day and automatically incorporates any factors affecting entitlement by way of the Net Adjustment Factor implicit in respect of any non trading day since the prior trading day.
Defining Entitlement for any trading day in Single Expression
Since for any trading day other than a trading day that is a Roll Day (and that is not a Disruption Day)

[{P₁₍ᵣ₎×W₁₍ᵣ₎+P₂₍ᵣ₎×W^{$}₍ᵣ₎}/R₍ₜ₎]/[{P₁₍ᵣ₋₁₎×W₁₍ᵣ₋₁₎+P₂₍ᵣ₋₁₎×W^{$}₍ᵣ₋₁₎}/R₍ₜ₋₁₎]

is equal to one (1), then Entitlement for any trading day may be expressed quantitatively in the form of a single expression

E₍ₜ₎=E₍ₜ₋₁₎×[{P₁₍ᵣ₎×W₁₍ᵣ₎+P₂₍ᵣ₎×W^{$}₍ᵣ₎}/R₍ₜ₎]/[{P₁₍ᵣ₋₁₎×W₁₍ᵣ₋₁₎+P₂₍ᵣ₋₁₎×W^{$}₍ᵣ₋₁₎}/R₍ₜ₋₁₎]×F^{(m)}

### Entitlement—Variation (C)

This variation (C) is an alternative to variation (A) for calculating Entitlement for any calendar day—that is for a Non Roll Day outside or within a Roll period and for a Roll Day of a Roll period. However, formulaic construction differs in that the Entitlement is disaggregated into component parts in respect of Marker Contracts C₁ and C₂ to which it is attributable, and the net adjustment factor applied with the relevant weight of the parts which are then summed.

### Entitlement for a Non-Roll Day

As in variation (A), for any calendar day c that is a Non-Roll day r (outside or within a Roll period) and there is a Net Adjustment Factor to be accounted for, Entitlement E_{(c)} is equal to the previous calendar day's Entitlement E_{(c-1)} multiplied by the Net Adjustment Factor F and expressed quantitatively in the form

E_{(c)}=E_{(c-1)}×F

where
E_{(c)} is Entitlement for a calendar day c for any Non-Roll Day in respect of r where r=0
E_{(c-1)} is the Entitlement on the calendar day immediately prior to calendar day c
F is the Net Adjustment Factor
c is a calendar day to which there is a corresponding r
   Entitlement for any calendar day that is a Roll Day of a Roll period
   In the Roll process there are distinct elements of Entitlement in respect of Marker Contracts that can give rise to changes in Entitlement, and the Entitlement calculation for each element is distinctive. The construction of this variation incorporates the Net Adjustment Factor by applying it within each element which then sum to Entitlement of the security. There is more than on way to structure such a variation and the following is one approach.

### Derivation

The elements of entitlement in this variation C that together make up Entitlement E are:
E_{X} Entitlement in respect of the proportion of C₁ contracts not yet Rolled
E_{Y} Entitlement in respect of the proportion of C₁ contracts Rolled into C₂ contracts on the current Roll Day and previously rolled on prior Roll Days of the Roll period

### Therefore

E=E_{X}+E_{Y}

P₁ in respect of E_{X} and P₂ in respect of E_{Y} are each weighted in the Roll process. As with other variations the proportion Rolled each day may vary or be equally weighted and the proportion of C₁ contracts rolled each Roll Day gives rise to a corresponding weight in respect P₁ of C₁ and P₂ of C₂. Unlike variations (A) and (B) that adopts a ratio approach where the Net Adjustment Factor is applied independently of the weights W₁₍ᵣ₎ and W^{$}₍ᵣ₎, in this variation the Net Adjustment Factor is embedded within the weights which are represented by Eₓ in respect of P₁ and E_{y} in respect of P₂ such that for a Roll Day r

E_{X(r)}=(P₁₍ᵣ₎×Eₓ₍ᵣ₎)/R₍ᵣ₎

E_{Y(r)}=(P₂₍ᵣ₎×E_{y(r)})/R₍ᵣ₎

Combining these elements yields an expression for Entitlement E_{(c)} for a calendar day that is a Roll Day r in the form of

E_{(c)}={(P₁₍ᵣ₎×Eₓ₍ᵣ₎)+(P₂₍ᵣ₎×E_{y(r)})}/R₍ᵣ₎

The following tables illustrate the form of, Eₓ₍ᵣ₎, and E_{y(r)} for a 5 day Roll. In Table 1, Roll days are consecutive to the completion of the Roll. In Table 2, Roll days are both consecutive and non consecutive with Non-Roll days occurring after the commencement and before the completion of the Roll period.

TABLE 1

| Day | | Eₓ₍ᵣ₎ | E_{y(r)} |
|---|---|---|---|
| S | c, r = 0 | E_{(c)} | |
| M | c, r = 1 | Eₓ₍₁₎ = Eₓ₍₀₎ × (W₁₍₁₎/W₁₍₀₎) × F | E_{y(1)} = {Eₓ₍₀₎ × (J₁₍₁₎ × P₁₍₁₎/P₂₍ₗ₎)}× F |
| T | c, r = 2 | Eₓ₍₂₎ = Eₓ₍₁₎ × (W₁₍₂₎/W₁₍₁₎) × F | E_{y(2)} = [{Eₓ₍₁₎ × (J₁₍₂₎ × P₁₍₂₎/P₂₍₂₎)} + E_{y(1)}] × F |
| W | c, r = 3 | Eₓ₍₃₎ = Eₓ₍₂₎ × (W₁₍₃₎/W₁₍₂₎) × F | E_{y(3)} = [{Eₓ₍₂₎ × (J₁₍₃₎ × P₁₍₃₎/P₂₍₃₎)} + E_{y(2)}] × F |
| T | c, r = 4 | Eₓ₍₄₎ = Eₓ₍₃₎ × (W₁₍₄₎/W₁₍₃₎) × F | E_{y(4)} = [{Eₓ₍₃₎ × (J₁₍₄₎ × P₁₍₄₎/P₂₍₄₎)} + E_{y(3)}] × F |
| F | c, r = 5 | Eₓ₍₅₎ = Eₓ₍₄₎ × (W₁₍₅₎/W₁₍₄₎) × F | E_{y(5)} = [{Eₓ₍₄₎ × (J₁₍₅₎ × P₁₍₅₎/P₂₍₅₎)} + E_{y(4)}] × F |
| S | c, r = 0 | E_{(c)} | |

TABLE 2

| Day | | Eₓ₍ᵣ₎ | E_{y(r)} |
|---|---|---|---|
| M | c, r = 0 | E_{(c)} | |
| T | c, r = 1 | Eₓ₍₁₎ = Eₓ₍₀₎ × (W₁₍₁₎/W₁₍₀₎) × F | E_{y(1)} = {Eₓ₍₀₎ × (J₁₍₁₎ × P₁₍₁₎/P₂₍ₗ₎)}× F |
| W | c, r = 2 | Eₓ₍₂₎ = Eₓ₍₁₎ × (W₁₍₂₎/W₁₍₁₎) × F | E_{y(2)} = [{Eₓ₍₁₎ × (J₁₍₂₎ × P₁₍₂₎/P₂₍₂₎)} + E_{y(1)}] × F |
| T | c, r = 3 | Eₓ₍₃₎ = Eₓ₍₂₎ × (W₁₍₃₎/W₁₍₂₎) × F | E_{y(3)} = [{Eₓ₍₂₎ × (J₁₍₃₎ × P₁₍₃₎/P₂₍₃₎)} + E_{y(2)}] × F |
| F | c, r = 4 | Eₓ₍₄₎ = Eₓ₍₃₎ × (W₁₍₄₎/W₁₍₃₎) × F | E_{y(4)} = [{Eₓ₍₃₎ × (J₁₍₄₎ × P₁₍₄₎/P₂₍₄₎)} + E_{y(3)}] × F |
| S | c, r = 0 | E_{(c)} | |
| S | c, r = 0 | E_{(c)} | |
| M | c, r = 5 | Eₓ₍₅₎ = Eₓ₍₄₎ × (W₁₍₅₎/W₁₍₄₎) × F | E_{y(5)} = [{Eₓ₍₄₎ × (J₁₍₅₎ × P₁₍₅₎/P₂₍₅₎)} + E_{y(4)}] × F |
| T | c, r = 0 | E_{(c)} | |

### Therefore

$$\begin{matrix}{E}_{x ( r )} = {E}_{x ( r - 1 )} \times ( {W}_{1 ( r )} / {W}_{1 ( r - 1 )} ) \times {FE}_{y ( r )} \\ = \sum \{ \begin{matrix}{E}_{x ( n - 1 )} \times ( 1 / {W}_{1 ( n - 1 )} ) \times \\ ( {J}_{1 ( n )} \times {P}_{1 ( n )} / {P}_{2 ( n )} ) \times F\end{matrix} \} \\ = \sum {E}_{y ( n )}\end{matrix} \qquad$$

Where Σ has a range n=1 to r such that E_{y(1)}+E_{y(2)}

Entitlement E_{(c)} on a calendar day which is a Roll Day of a Roll period expressed in the form

E_{(c)}={(P₁₍ᵣ₎×Eₓ₍ᵣ₎)+(P₂₍ᵣ₎×E_{y(r)})}/R₍ᵣ₎

may therefore also be expressed as

E_{(c)}=[{P₁₍ᵣ₎×Eₓ₍ᵣ₋₁₎×(W₁₍ᵣ₎/W₁₍ᵣ₋₁₎)×F}+{P₂₍ᵣ₎×Σ(Eₓ₍ₙ₋₁₎×1/W₁₍ₙ₋₁₎×(J₍ₙ₎×P₁₍ₙ₎P₂₍ₙ₎)×F)}]÷R₍ᵣ₎

where
E_{(c)} is Entitlement for a calendar day c for any Roll day in respect of r where r>0
c is a calendar day to which there is a corresponding r
P₁₍ᵣ₎ is the price of the Current Marker Contract C₁ on day r
P₂₍ᵣ₎ is the price of the Next Marker Contract C₂ on day r
W₁₍ᵣ₎ is the weight (proportion) accorded to the Current Marker Contract C₁ reflecting C₁ not yet rolled at the completion of day r, where
   W₁₍ᵣ₎=1−ΣJ₁₍ₙ₎ Σ has a range, n=1 to r in the Roll period
   W₁₍ᵣ₎=1 for a Non-Roll Day r=0 outside the period Roll,
   W₁₍ᵣ₋₁₎ in the Roll is the weight of the prior Roll Day
J₁₍ᵣ₎ is the weight (proportion) of C₁ Rolled on a day r, where
   ΣJ₁₍ₙ₎=1 Σ has a range n=1 to d and
   J₁₍ₙ₎=1/d only where the amount Rolled is equally weighted during the Roll for each day r
F is a Net Adjustment Factor
Eₓ₍ᵣ₎=Eₓ₍ᵣ₋₁₎×(W₁₍ᵣ₎/W₁₍ᵣ₋₁₎)×F
   except where a Roll Day (r>0) follows a Non Roll Day (r=0),
   then
   Eₓ₍ᵣ₋₁₎=E_{(c-1)} (ie entitlement for the prior calendar day)
E_{y(r)}=Σ{Eₓ₍ₙ₋₁₎×(1/W₁₍ₙ₋₁₎)×(J₁₍ₙ₎×P₁₍ₙ₎/P₂₍ₙ₎)×F}=ΣE_{y(n)} where Σ has a range n=1 to r
   such that E_{y(1)}+E_{y(2)}+ . . . +E_{y(r)}
R₍ᵣ₎ is the security Reference Price on day r
   where R₍ᵣ₎=P₁₍ᵣ₎W₁₍ᵣ₎+P₂₍ᵣ₎(1−W₁₍ᵣ₎)
d is the total number of Roll Days on which the Roll takes place
r for a Roll Day r, is greater than 0 (zero), has values of 1 through d that correspond to the number of the Roll Day, and for which there is a corresponding calendar day c referring to the same day and,
   for a Non-Roll day r, has a value of 0 (zero), and for which there is a corresponding calendar day c, referring to the same day
n a is an integer counter

### Entitlement—Variation (D)

### Entitlement Calculated for any Trading Day

This variation (D) is an alternative to variation (C) for calculating Entitlement. It provides for Entitlement to be calculated for any Trading Day within and outside the Roll period using the same general structure as Entitlement for a calendar day articulated in variation C where Entitlement is disaggregated into component parts in respect of Marker Contracts C₁ and C₂, and the net adjustment factor applied within the relevant weight of the parts which are then summed to Entitlement.
Entitlement E₍ₜ₎ for a Trading Day, outside a Roll period (that is not a Disruption Day) is

E₍ₜ₎=E₍ₜ₋₁₎×F^{(m)}

where
E₍ₜ₎ is Entitlement on a trading day t
E₍ₜ₋₁₎ is Entitlement on the trading day prior to trading day t
t is a trading day that is not a Disruption Day
F is the Net Adjustment Factor
m is an integer counter in respect of F that is the number of days equal to the current trading day plus the number of non trading days since the prior trading day where F^{(m)}
   Entitlement E₍ₜ₎ for a Trading Day that is a Roll Day (that is not a Disruption Day) within a Roll period and there is a Net Adjustment Factor to be accounted for.

E₍ₜ₎=E_{X(r)}+E_{Y(r)}

P₁ in respect of E_{X} and P₂ in respect of E_{Y} are each weighted in the Roll process. As with other variations the proportion Rolled each day may vary or be equally weighted and the proportion of C₁ contracts rolled each Roll Day gives rise to a corresponding weight in respect P₁ of C₁ and P₂ of C₂. Unlike variations (A) and (B) that adopts a ratio approach and the Net Adjustment Factor applied independently of the weights W₁₍ᵣ₎ and W^{$}₍ᵣ₎, and similarly to variation C, in this variation the Net Adjustment Factor is embedded within the weights which are represented by Eₓ in respect of P₁ and E_{y} in respect of P₂ such that for a Trading day t that is a Roll Day r

E_{X(r)}=(P₁₍ᵣ₎×Eₓ₍ᵣ₎)/R₍ᵣ₎

E_{Y(r)}=(P₂₍ᵣ₎×E_{y(r)})/R₍ᵣ₎

Combining these elements yields an expression for Entitlement E₍ₜ₎ for a Trading Day that is a Roll Day r in the form of

E₍ₜ₎={(P₁₍ᵣ₎×Eₓ₍ᵣ₎)+(P₂₍ᵣ₎×E_{y(r)})}/R₍ₜ₎

The following table illustrates the form of, Eₓ₍ᵣ₎, and E_{y(r)} for Trading days t for a 5 day Roll (d=5 and r=1 to 5) with Non Trading days nt on the weekend.

TABLE

| Day | | Eₓ₍ᵣ₎ | E_{y(r)} |
|---|---|---|---|
| M | t, r = 0 | E₍ₜ₎ | |
| T | t, r = 1 | Eₓ₍₁₎ = E₍ₒ₎ × (W₁₍₁₎/W₁₍₀₎) × F | E_{y(1)} = {E₍ₜ₋₁₎ × (J₁₍₁₎ × P₁₍₁₎/P₂₍₁₎)} × F |
| W | t, r = 2 | Eₓ₍₂₎ = Eₓ₍₁₎ × (W₁₍₂₎/W₁₍₁₎) × F | E_{y(2)} = [{Eₓ₍₁₎ × (J₁₍₂₎ × P₁₍₂₎/P₂₍₂₎)} + E_{y(1)}] × F |
| T | t, r = 3 | Eₓ₍₃₎ = Eₓ₍₂₎ × (W₁₍₃₎/W₁₍₂₎) × F | E_{y(3)} = [{Eₓ₍₂₎ × (J₁₍₃₎ × P₁₍₃₎/P₂₍₃₎)} + E_{y(2)}] × F |
| F | t, r = 4 | Eₓ₍₄₎ = Eₓ₍₃₎ × (W₁₍₄₎/W₁₍₃₎) × F | E_{y(4)} = [{Eₓ₍₃₎ × (J₁₍₄₎ × P₁₍₄₎/P₂₍₄₎)} + E_{y(3)}] × F |
| S, | nt | | |
| S, | nt | | |
| M | t, r = 5 | Eₓ₍₅₎ = Eₓ₍₄₎ × (W₁₍₅₎/W₁₍₄₎) × F³ | E_{y(5)} = [{Eₓ₍₄₎ × (J₁₍₅₎ × P₁₍₅₎/P₂₍₅₎)} + E_{y(4)}] × F³ |
| T | t, r = 0 | E₍ₜ₎ | |

### Therefore

Eₓ₍ᵣ₎=Eₓ₍ᵣ₋₁₎×(W₁₍ᵣ₎/W₁₍ᵣ₋₁₎)×F^{(m)}

and

E_{y(r)}=Σ{Eₓ₍ₙ₋₁₎×(1/W₁₍ₙ₋₁₎)×(J₁₍ₙ₎×P₁₍ₙ₎P₂₍ₙ₎)×F^{(m)}}=ΣE_{y(n)}
where Σ has a range n=1 to r such that E_{y(1)}+E_{y(2)}+ . . . +E_{y(r)}
   Entitlement E₍ₜ₎ on a Trading day which is a Roll Day of a Roll period expressed in the form

E₍ₜ₎={(P₁₍ᵣ₎×Eₓ₍ᵣ₎)+(P₂₍ᵣ₎×E_{y(r)})}/R₍ₜ₎

may therefore also be expressed as

E₍ₜ₎=[{P₁₍ᵣ₎×Eₓ₍ᵣ₋₁₎×(W₁₍ᵣ₎W₁₍ᵣ₋₁₎)×F^{(m)}}+{P₂₍ᵣ₎×Σ(Eₓ₍ₙ₋₁₎×1/W₁₍ₙ₋₁₎×(J₍ₙ₎×P₁₍ₙ₎/P₂₍ₙ₎)×F^{(m)}}]÷R₍ₜ₎

where
E₍ₜ₎ is Entitlement on a trading day t in respect of a Roll day r where r>0
E₍ₜ₋₁₎ is Entitlement on the trading day prior to trading day t
t is a trading day to which there is a corresponding r and is not a Disruption Day
Eₓ₍ᵣ₎=Eₓ₍ᵣ₋₁₎×(W₁₍ᵣ₎/W₍ᵣ₋₁₎)×F^{(m)}
E_{y(r)={ΣE}ₓ₍ₙ₋₁₎×(1/W₁₍ₙ₋₁₎)×(J₁₍ₙ₎×(P₁₍ₙ₎/P₂₍ₙ₎)×F^{(m)}}=ΣE_{y(n)} where Σ has a range n=1 to r such that E_{y(1)}+E_{y(2)}+ . . . +E_{y(r)}
   Eₓ₍ᵣ₋₁₎ Eₓ₍ᵣ₎ of the prior trading day and
   where Eₓ₍ᵣ₋₁₎=Eₓ₍₀₎=E₍ₜ₎
F is the Net Adjustment Factor
m is an integer counter in respect of F that is the number of days equal to the current trading day plus the number of non trading days since the prior trading day where F^{(m)}
P₁₍ᵣ₎ is the price of the Current Marker Contract C₁ on trading day t
P₂₍ᵣ₎ is the price of the Next Marker Contract C₂ on trading day t
W₁₍ᵣ₎ is the weight (proportion) accorded to the Current Marker Contract C₁ reflecting C₁ not yet rolled at the completion of trading day t that is a Roll day r, where
   W₁₍ᵣ₎=1−ΣJ₁₍ₙ₎ Σ has a range, n=1 to r in the Roll period
      W₁₍ᵣ₌₀₎=1 for a trading day outside the Roll period
   W₁₍ᵣ₋₁₎ is the weight for the prior trading day
J₁₍ᵣ₎ is the weight (proportion) of C₁ Rolled on a day r, where
   ΣJ₁₍ᵣ₎=1 Σ has a range n=1 to d and
   J₁₍ᵣ₎=1/d only where the amount Rolled is equally weighted during the Roll for each day r
d is the total number of Roll Days on which the Roll takes place
r for a Roll Day r, is greater than 0 (zero), has integer values of 1 through d that correspond to the number of the Roll Day, there is a corresponding Trading day t referring to the same day and,
   for a Non-Roll Day r, has a value of 0 (zero), there is a corresponding Trading day t referring to the same day
n is an integer counter
R₍ₜ₎ is the security Reference Price on trading day t
   where R₍ₜ₎=P₁₍ᵣ₎W₁₍ᵣ₎+P₂₍ᵣ₎(1−W₁₍ᵣ₎

### Creations, Redemptions and Secondary Market

Under an exchange traded fund (ETF) structure the computer program of this invention may create and redeem securities on demand on any trading day that is not a disruption day. The primary issuance of a security is typically only available to approved participants (AP's) via subscription who place the securities with investors or on-sell them to investors in the secondary market typically a regulated stock exchange. The securities are tradeable in the secondary market typically a regulated stock exchange providing investors and AP's with the ability buy and sell the securities. The program automatically calculates the security value in real time or delayed during the trading day and transmits the value to the public domain over a network to a market data publication service for distribution or posted to the internet. Excepting there may be transaction costs, for a security on a non disrupted trading day the program of this invention calculates a creation price is equal to the redemption price.
Thus Security Price=Reference Price×Entitlement=Creation Price=Redemption Price=Underlying asset price×Entitlement. The security typically confers no right to the underlying assets at redemption. Rather the security holder is entitled to the equivalent value of the underlying assets per security in cash. The creation or redemption value of the Security is based on the settlement price or a market traded price as permitted
The ability for approved participants to create and redeem securities at fair value on demand on any non disrupted trading day in pursuit of arbitrage profits from deviations from fair value has the affect of limiting tracking error of the security. In other embodiments of this invention the form of underlying asset held that backs the security is optionally:
futures contracts
contractual obligations with corresponding terms that match the Security based on futures contract
liquid forward market paper contracts
contractual obligations with corresponding terms that match the Security based on forward market paper contract terms
   From the above it can be seen that this invention provides a security based on futures, commodity or non-commodity, that can be exchange traded in a transparent way with an easily calculated entitlement attributable to the roll and any adjustments that leaves no mismatch at rollover and does not require rebalancing.

Aspects of the present invention may be embodied in computer code stored in a tangible medium and being executable utilizing a computing device. For non-limiting purposes of explanation only, “computer”, as referred to herein, refers to a general purpose computing device that includes a processor. “Processor”, as used herein, refers generally to a device including a Central Processing Unit (CPU), such as a microprocessor. A CPU generally includes an arithmetic logic-unit (ALU), which performs arithmetic and logical operations, and a control unit, which extracts instructions (e.g., the code) from memory and decodes and executes them, calling on the ALU when necessary. “Memory”, as used herein, generally refers to one or more devices capable of storing data, such as in the form of chips. Memory may take the form of one or more random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including the processor. Memory may be internal or external to the computer. Such memory may store a computer program, e.g., code or a sequence of instructions being operable by the processor. One type of computer executable code typically stored in memory so as to be executable by an Internet enabled computer is a browser application.

Those skilled in the art will realize that this invention may be implemented in a range of various embodiments without departing from the core teaching of this invention.

1. A computer program containing executable instructions for creating and managing an exchange traded, structured investment security which is based on an asset and is linked through its entitlement and reference price to the value or performance of the asset as measured against an index, the said asset having a forward price structure, a forward market, and an expiration date, in which the computer program is preloaded with data relating to said asset, the security price, reference price, entitlement, current and next market contract prices, trading day dates and weightings and said computer program uses the preloaded information to roll the asset forward and into another asset with a later expiry date and said program calculates the Security Price using the formula:
S=R×E
where
S is the Security Price
R is the Reference Price
E is the value based Entitlement of the Security
In which the reference price is calculated by the formula
R=P₁W₁+P₂(1−W₁)
where
R is the security Reference Price
P₁ is the price of the Current Marker Contract C₁
P₂ is the price of the Next Marker Contract C₂
W₁ is the weight accorded to the Current Marker Contract C₁ at the completion of any calendar day, where
0≦W₁≦1 for any calendar day that is a Roll Day
W₁=1 for any calendar day that is a Non-Roll Day
P₁ and P₂ are both market prices during the trading day or both end-of-day prices as the relevant circumstances require where the end-of-day price is the published price for the asset contract as determined in accordance with the rules, regulations and procedures of the relevant asset market and laws of the relevant jurisdiction in which entitlement is the claim on the number (including fraction thereof) of the underlying asset units or equivalent held per security that back each security, to which a security holder is entitled per security at redemption.

2. The computer program for managing an exchange traded, structured investment security of claim 1 wherein the entitlement E for any calendar day c is calculated by the formula:
E_{(c)}=E_{(c-1)}×(E₍ᵣ₎/E₍ᵣ₋₁₎)×F
where
E_{(c)} is Entitlement for a calendar day c
E_{(c-1)} is the Entitlement on the calendar day prior to calendar day c
c is a calendar day to which there is a corresponding r
E₍ᵣ₎ is Entitlement for a calendar day that is a Roll Day (r)
where
E₍ᵣ₎={P₁₍ᵣ₎×W₁₍ᵣ₎+P₂₍ᵣ₎×W^{$}₍ᵣ₎}/R₍ᵣ₎
E₍ᵣ₋₁₎ Entitlement for a calendar day that is the prior Roll Day (r−1) to Roll Day (r) where
E₍ᵣ₋₁₎={P₁₍ᵣ₋₁₎×W₁₍ᵣ₋₁₎+P₂₍ᵣ₋₁₎×W^{$}₍ᵣ₋₁₎}/R₍ᵣ₋₁₎
E(r)/E₍ᵣ₋₁₎ is a value based entitlement ratio of the current and prior Roll Days, is defined as equal to one (1) for any day other than a Roll Day, such that E_{(c)}=E_{(c-1)}×F
F is the Net Adjustment Factor applied independently of weights where
F=(1−f %) and
f % is the percentage per annum rate for any debits minus the percentage per annum rate for any credits (applied as the relevant circumstances require)
P₁₍ᵣ₎ is the price of the Current Marker Contract C₁ on day r
P₂₍ᵣ₎ is the price of the Next Marker Contract C₂ on day r
W₁₍ᵣ₎ is the weight (proportion) accorded to the Current Marker Contract C₁ reflecting C₁ not yet rolled at the completion of day r, where
W₁₍ᵣ₎=1−ΣJ₁₍ₙ₎ Σ has a range, n=1 to r in the Roll period
W₁₍ᵣ₎=1 for a Non-Roll Day r=0 outside the period Roll,
W₁₍ᵣ₋₁₎ in the Roll is the weight of the prior Roll Day
J₍ᵣ₎ is the weight (proportion) of C₁ Rolled on a day r, where
ΣJ₁₍ₙ₎=1 Σ has a range n=1 to d and
J₁₍ᵣ₎=1/d only where the amount Rolled is equally weighted during the Roll for each day r
d is the total number of Roll Days on which the Roll takes place
r for a Roll Day r, is greater than 0 (zero), has integer values of 1 through d that correspond to the number of the Roll Day, there is a corresponding calendar day c referring to the same day and,
for a Non-Roll Day r, has a value of 0 (zero), there is a corresponding calendar day c referring to the same day
n is an integer counter
W^{$}₍ᵣ₎ is the weight that equates the value of C₁ disposed to the value of C₂ acquired in the Roll process at the completion of each Roll Day r, and
W^{$}₍ᵣ₎=Σ{J₁₍ₙ₎×(P₁₍ₙ₎/P₂₍ₙ₎)} Σ has a range n=0 to r
R₍ᵣ₎ is the Reference Price on day r.

3. The computer program for managing an exchange traded, structured investment security of claim 1 wherein the entitlement E for any trading day t, is calculated by the formula:
E₍ₜ₎=E₍ₜ₋₁₎×(E₍ᵣ₎/E₍ᵣ₋₁₎)×F^{(m)}
where
E₍ₜ₎ is Entitlement on a trading day t
E₍ₜ₋₁₎ is Entitlement on the trading day prior to trading day t
t is a trading day to which there is a corresponding r and is not a Disruption Day
E₍ᵣ₎ is Entitlement for a trading day that is a Roll Day (r)
where
E₍ᵣ₎={P₁₍ᵣ₎×W₁₍ᵣ₎+P₂₍ᵣ₎×W^{$}₍ᵣ₎}/R₍ₜ₎
E₍ᵣ₋₁₎ Entitlement for a trading day that is the prior Roll Day (r−1) to Roll Day (r) where
E₍ᵣ₋₁₎={P₁₍ᵣ₋₁₎×W₁₍ᵣ₋₁₎+P₂₍ᵣ₋₁₎×W^{$}₍ᵣ₋₁₎}/R₍ₜ₋₁₎
E₍ᵣ₎/E₍ᵣ₋₁₎ is a value based entitlement ratio of the current and prior Roll Days, is defined as equal to one (1) for any day other than a Roll Day, such that E₍ₜ₎=E₍ₜ₋₁₎×F^{(m)}
F is the Net Adjustment Factor is applied independently of weights, where
F=(1−f %) and
f % is the percentage per annum rate for any debits minus the percentage per annum rate for any credits (applied as the relevant circumstances require)
m is an integer counter in respect of F, is the number of days equal to the current trading day plus the number of non trading days since the prior trading day,
and, if the quantum of F differs on one or more such days, F^{(m)}=F_{(c)}×F_{(c-1)}× . . . ×F_{(c-n)} where c is the current trading day and c−1 to n are non trading days since the prior trading day
P₁₍ᵣ₎ is the price of the Current Marker Contract C₁ on trading day t
P₂₍ᵣ₎ is the price of the Next Marker Contract C₂ on trading day t
W₁₍ᵣ₎ is the weight (proportion) accorded to the Current Marker Contract C₁ reflecting C₁ not yet rolled at the completion of trading day t that is a Roll day r, where
W₁₍ᵣ₎=1−ΣJ₁₍ₙ₎ Σ has a range, n=1 to r in the Roll period
W₁₍ᵣ₌₀₎=1 for a trading day outside the Roll period
W₁₍ᵣ₋₁₎ is the weight for the prior trading day
J₁₍ᵣ₎ is the weight (proportion) of C₁ Rolled on a day r, where
ΣJ₁₍ₙ₎=1 Σ has a range n=1 to d and
J₁₍ᵣ₎=1/d only where the amount Rolled is equally weighted during the Roll for each day r
d is the total number of Roll Days on which the Roll takes place
r for a Roll Day r, is greater than 0 (zero), has integer values of 1 through d that correspond to the number of the Roll Day, there is a corresponding trading day t referring to the same day and,
for a Non-Roll Day r, has a value of 0 (zero), there is a corresponding trading day t referring to the same day
n is an integer counter
W^{$}₍ᵣ₎ is the weight that equates the value of C₁ disposed to the value of C₂ acquired in the Roll process at the completion of each Roll Day r, and
W^{$}₍ᵣ₎=Σ{J₁₍ₙ₎×(P₁₍ₙ₎/P₂₍ₙ₎)} Σ has a range n=0 to r
R₍ₜ₎ is the Reference Price on day t.

4. The computer program for managing an exchange traded, structured investment security of claim 1 in which entitlement E for any calendar day c is calculated by the formula:
for a Roll Day
E_{(c)}=E_{X(r)}E_{Y(r)}
and,
for a Non Roll Day
E_{(c)}=E_{(c-1)}×F
where
E_{(c)} is Entitlement for a calendar day c for any Roll day in respect of r where r>0
E_{(c-1)} is the Entitlement on the calendar day prior to calendar day c
c is a calendar day to which there is a corresponding r
E_{X} is Entitlement in respect of the proportion of C₁ contracts not yet rolled
E_{Y} is Entitlement in respect of the proportion of C₁ contracts Rolled into C₂ contracts on the current Roll Day and previously rolled on prior Roll Days of the Roll period
E_{X(r)}=(P₁₍ᵣ₎×Eₓ₍ᵣ₎)/R₍ᵣ₎
E_{Y(r)}=(P₂₍ᵣ₎×E_{y(r)})/R₍ᵣ₎
P₁₍ᵣ₎ is the price of the Current Marker Contract C₁ on day r
P₂₍ᵣ₎ is the price of the Next Marker Contract C₂ on day r
W₁₍ᵣ₎ is the weight (proportion) accorded to the Current Marker Contract C₁ reflecting C₁ not yet rolled at the completion of day r, where
W₁₍ᵣ₎=1−ΣJ₁₍ₙ₎ Σ has a range, n=1 to r in the Roll period
W₁₍ᵣ₎=1 for a Non-Roll Day r=0 outside the Roll period
W₁₍ᵣ₋₁₎ is the weight of the prior Roll Day
J₁₍ᵣ₎ is the weight (proportion) of C₁ Rolled on a day r, where
Σ J₁₍ₙ₎=1 has a range n=1 to d and
J₁₍ᵣ₎=1/d only where the amount Rolled is equally weighted during the Roll for each day r
F is a Net Adjustment Factor is embedded with the weights, where
F=(1−f %) and
f % is the percentage per annum rate for any debits minus the percentage per annum rate for any credits (applied as the relevant circumstances require)
Eₓ₍ᵣ₎=Eₓ₍ᵣ₋₁₎×(W₁₍ᵣ₎/W₁₍ᵣ₋₁₎)×F
except where a Roll Day (r>0) follows a Non Roll Day (r=0), then
Eₓ₍ᵣ₋₁₎=E_{(c-1)} (ie entitlement for the prior calendar day)
E_{y(r)}=Σ{Eₓ₍ₙ₋₁₎×(1/W₍ₙ₋₁₎)×(J₁₍ₙ₎×P₁₍ₙ₎/P₂₍ₙ₎)×F}=ΣE_{y(n)} where Σ has a range n=1 to r
such that E_{y(1)}+E_{y(2)}+ . . . +E_{y(r)}
R₍ᵣ₎ is the security Reference Price on day r where R₍ᵣ₎=P₁₍ᵣ₎W₁₍ᵣ₎+P₂₍ᵣ₎(1−W₁₍ᵣ₎)
d is the total number of Roll Days on which the Roll takes place
r for a Roll Day r, is greater than 0 (zero), has values of 1 through d that correspond to the number of the Roll Day, and for which there is a corresponding calendar day c referring to the same day and,
for a Non-Roll day r, has a value of 0 (zero), and for which there is a corresponding calendar day c, referring to the same day
n a is an integer counter.

5. The computer program for managing an exchange traded, structured investment security of claim 1 wherein the entitlement E for any trading day t, is calculated by the formula:
for a Roll Day
E₍ₜ₎=E_{X(r)}+E_{Y(r)}
and,
for a Non Roll Day
E₍ₜ₎=E₍ₜ₋₁₎×F
where
E₍ₜ₎ is Entitlement on a trading day t in respect of a Roll day r where r>0
E₍ₜ₋₁₎ is Entitlement on the trading day prior to trading day t
t is a trading day to which there is a corresponding r and is not a Disruption Day
E_{X} is Entitlement in respect of the proportion of C₁ contracts not yet rolled
E_{Y} is Entitlement in respect of the proportion of C₁ contracts Rolled into C₂ contracts on the current Roll Day and previously rolled on prior Roll Days of the Roll period
E_{X(r)}=(P₁₍ᵣ₎×Eₓ₍ᵣ₎)/R₍ᵣ₎
E_{Y(r)}=(P₂₍ᵣ₎×E_{y(r))}/R₍ᵣ₎
P₁₍ᵣ₎ is the price of the Current Marker Contract C₁ on trading day t
P₂(r) is the price of the Next Marker Contract C₂ on trading day t
Eₓ₍ᵣ₎=Eₓ₍ᵣ₋₁₎×(W₁₍ᵣ₎/W₁₍ₙ₋₁₎)×F^{(m)}
E_{y(r)}=Σ{Eₓ₍ₙ₋₁₎×(1/W₁₍ₙ₋₁₎×(J₁₍ₙ₎×P₁₍ₙ₎/P₂₍ₙ₎×F^{(m)}}=ΣE_{y(n)} where Σ has a range n=1 to r
such that E_{y(1)}+E_{y(2)}+ . . . +(E_{y(r)}
Eₓ₍ᵣ₋₁₎ is Eₓ₍ᵣ₎ of the prior trading day and
where Eₓ₍ᵣ₋₁₎=Eₓ₍₀₎=E₍ₜ₎
F is the Net Adjustment Factor for the roll day is embedded with the weights, where
F=(1−f %) and
f % is the percentage per annum rate for any debits minus the percentage per annum rate for any credits (applied as the relevant circumstances require)
m is an integer counter in respect of F that is the number of days equal to the current trading day plus the number of non trading days since the prior trading day
and, if the quantum of F differs on one or more such days, F^{(m)}=F_{(c)}×F_{(c-1)}× . . . ×F_{(c-1)} where c is the current trading day and c−1 to n are non trading days since the prior trading day
W₁₍ᵣ₎ is the weight (proportion) accorded to the Current Marker Contract C₁ reflecting C₁ not yet rolled at the completion of trading day t that is a Roll day r, where
W₁₍ᵣ₎=1−ΣJ₁₍ₙ₎ Σ has a range, n=1 to r in the Roll period
W₁₍ᵣ₌₀₎=1 for a trading day outside the Roll period
W₁₍ᵣ₋₁₎ is the weight for the prior trading day
J₁₍ᵣ₎ is the weight (proportion) of C₁ Rolled on a day r, where
ΣJ₁₍ₙ₎=1 Σ has a range n=1 to d and
J₁₍ᵣ₎=1/d only where the amount Rolled is equally weighted during the Roll for each day r
d is the total number of Roll Days on which the Roll takes place
r for a Roll Day r, is greater than 0 (zero), has integer values of 1 through d that correspond to the number of the Roll Day, there is a corresponding trading day t referring to the same day and,
for a Non-Roll Day r, has a value of 0 (zero), there is a corresponding trading day t referring to the same day
n is an integer counter
R₍ₜ₎ is the security Reference Price on trading day t
where R₍ₜ₎=P₁₍ᵣ₎W₁₍ᵣ₎+P₂₍ᵣ₎(1−W₁₍ᵣ₎).

6. The computer program for managing an exchange traded, structured investment security as claimed in claim 1 wherein P1 and P2 are both market prices of a Marker futures contract during the trading day or both end of day prices as the relevant circumstances require where the end of day price is the settlement price of marker the futures contract as determined in accordance with the rules, regulations and procedures of the relevant futures exchange and laws of the relevant jurisdiction.

7. The computer program for managing an exchange traded, structured investment security of claim 6 wherein the entitlement E for any calendar day c is calculated by the formula:
E_{(c)}=E_{(c-1)}×(E₍ᵣ₎/E₍ᵣ₋₁₎)×F
where
E_{(c)} is Entitlement for a calendar day c
E_{(c-1)} is the Entitlement on the calendar day prior to calendar day c
c is a calendar day to which there is a corresponding r
E₍ᵣ₎ is Entitlement for a calendar day that is a Roll Day (r) where
E₍ᵣ₎={P₁₍ᵣ₎×W₁₍ᵣ₎+P₂₍ᵣ₎×W^{$}₍ᵣ₎}/R₍ᵣ₎
E₍ᵣ₋₁₎ Entitlement for a calendar day that is the prior Roll Day (r−1) to Roll Day (r) where
E₍ᵣ₋₁₎={P₁₍ᵣ₋₁₎×W₁₍ᵣ₋₁₎+P₂₍ᵣ₋₁₎×W^{$}₍ᵣ₋₁₎}/R₍ᵣ₋₁₎
E₍ᵣ₎/E₍ᵣ₋₁₎ is a value based entitlement ratio of the current and prior Roll Days, is defined as equal to one (1) for any day other than a Roll Day, such that E_{(c)}=E_{(c-1)}×F
F is the Net Adjustment Factor applied independently of weights where
F=(1−f %) and
f % is the percentage per annum rate for any debits minus the percentage per annum rate for any credits (applied as the relevant circumstances require)
P₁₍ᵣ₎ is the price of the Current Marker Contract C₁ on day r
P₂₍ᵣ₎ is the price of the Next Marker Contract C₂ on day r
W₁₍ᵣ₎ is the weight (proportion) accorded to the Current Marker Contract C₁ reflecting C₁ not yet rolled at the completion of day r, where
W₁₍ᵣ₎=1−ΣJ₁₍ₙ₎ Σ has a range, n=1 to r in the Roll period
W₁₍ᵣ₎=1 for a Non-Roll Day r=0 outside the period Roll,
W₁₍ᵣ₋₁₎ in the Roll is the weight of the prior Roll Day
J₁₍ᵣ₎ is the weight (proportion) of C₁ Rolled on a day r, where
ΣJ₁₍ₙ₎=1 Σ has a range n=1 to d and
J₁₍ᵣ₎=1/d only where the amount Rolled is equally weighted during the Roll for each day r
d is the total number of Roll Days on which the Roll takes place
r for a Roll Day r, is greater than 0 (zero), has integer values of 1 through d that correspond to the number of the Roll Day, there is a corresponding calendar day c referring to the same day and,
for a Non-Roll Day r, has a value of 0 (zero), there is a corresponding calendar day c referring to the same day
n is an integer counter
W^{$}₍ᵣ₎ is the weight that equates the value of C₁ disposed to the value of C₂ acquired in the Roll process at the completion of each Roll Day r, and
W^{$}₍ᵣ₎=Σ{J₁₍ₙ₎×(P₁₍ₙ₎/P₂₍ₙ₎))} Σ has a range n=0 to r
R₍ᵣ₎ is the Reference Price on day r.

8. The computer program for managing an exchange traded, structured investment security of claim 6 wherein the entitlement E for any trading day t, is calculated by the formula:
E₍ₜ₎=E₍ₜ₋₁₎×(E₍ᵣ₎/E₍ᵣ₋₁₎)×F^{(m)}
where
E₍ₜ₎ is Entitlement on a trading day t
E₍ₜ₋₁₎ is Entitlement on the trading day prior to trading day t
t is a trading day to which there is a corresponding r and is not a Disruption Day
E₍ᵣ₎ is Entitlement for a trading day that is a Roll Day (r) where
E₍ᵣ₎={P₁₍ᵣ₎×W₁₍ᵣ₎+P₂₍ᵣ₎×W^{$}₍ᵣ₎}/R₍ₜ₎
E₍ᵣ₋₁₎ Entitlement for a trading day that is the prior Roll Day (r−1) to Roll Day (r) where
E₍ᵣ₋₁₎={P₁₍ᵣ₋₁₎×W₁₍ᵣ₋₁₎+P₂₍ᵣ₋₁₎×W^{$}₍ᵣ₋₁₎}/R₍ₜ₋₁₎
E₍ᵣ₎/E₍ᵣ₋₁₎ is a value based entitlement ratio of the current and prior Roll Days, is defined as equal to one (1) for any day other than a Roll Day, such that E₍ₜ₎=E₍ₜ₋₁₎×F^{(m)}
F is the Net Adjustment Factor is applied independently of weights, where
F=(1−f %) and
f % is the percentage per annum rate for any debits minus the percentage per annum rate for any credits (applied as the relevant circumstances require)
m is an integer counter in respect of F, is the number of days equal to the current trading day plus the number of non trading days since the prior trading day,
and, if the quantum of F differs on one or more such days, F^{(m)}=F_{(c)}×F_{(c-1)}× . . . ×F_{(c-n)} where c is the current trading day and c−1 to n are non trading days since the prior trading day
P₁₍ᵣ₎ is the price of the Current Marker Contract C₁ on trading day t
P₂₍ᵣ₎ is the price of the Next Marker Contract C₂ on trading day t
W₁₍ᵣ₎ is the weight (proportion) accorded to the Current Marker Contract C₁ reflecting C₁ not yet rolled at the completion of trading day t that is a Roll day r, where
W₁₍ᵣ₎=1−ΣJ₁₍ₙ₎ Σ has a range, n=1 to r in the Roll period
W₁₍ᵣ₌₀₎=1 for a trading day outside the Roll period
W₁₍ᵣ₋₁₎ is the weight for the prior trading day
J₁₍ᵣ₎ is the weight (proportion) of C₁ Rolled on a day r, where
ΣJ₁₍ₙ₎=1 Σ has a range n=1 to d and
J₁₍ᵣ₎=1/d only where the amount Rolled is equally weighted during the Roll for each day r
d is the total number of Roll Days on which the Roll takes place
r for a Roll Day r, is greater than 0 (zero), has integer values of 1 through d that correspond to the number of the Roll Day, there is a corresponding trading day t referring to the same day and, for a Non-Roll Day r, has a value of 0 (zero), there is a corresponding trading day t referring to the same day
n is an integer counter
W^{$}₍ᵣ₎ is the weight that equates the value of C₁ disposed to the value of C₂ acquired in the Roll process at the completion of each Roll Day r, and
W^{$}₍ᵣ₎=Σ{J₁₍ₙ₎×(P₁₍ₙ₎/P₂₍ₙ₎)} Σ has a range n=0 to r
R₍ₜ₎ is the Reference Price on day t.

9. The computer program for managing an exchange traded, structured investment security of claim 6 in which entitlement E for any calendar day c is calculated by the formula:
for a Roll Day
E_{(c)}=E_{X(r)}+E_{Y(r)}
and,
for a Non Roll Day
E_{(c)}=E_{(c-1)}×F
where
E_{(c)} is Entitlement for a calendar day c for any Roll day in respect of r where r>0
E_{(c-1)} is the Entitlement on the calendar day prior to calendar day c
c is a calendar day to which there is a corresponding r
E_{X} is Entitlement in respect of the proportion of C₁ contracts not yet rolled
E_{Y} is Entitlement in respect of the proportion of C₁ contracts Rolled into C₂ contracts on the current Roll Day and previously rolled on prior Roll Days of the Roll period
E_{X(r)}=(P₁₍ᵣ₎×Eₓ₍ᵣ₎)/R₍ᵣ₎
E_{Y(r)}=(P₂₍ᵣ₎×E_{y(r)})/R₍ᵣ₎
P₁₍ᵣ₎ is the price of the Current Marker Contract C₁ on day r
P₂₍ᵣ₎ is the price of the Next Marker Contract C₂ on day r
W₁₍ᵣ₎ is the weight (proportion) accorded to the Current Marker Contract C₁ reflecting C₁ not yet rolled at the completion of day r, where
W₁₍ᵣ₎=1−ΣJ₁₍ₙ₎ Σ has a range, n=1 to r in the Roll period
W₁₍ᵣ₎=1 for a Non-Roll Day r=0 outside the Roll period
W^{1(r-1)} is the weight of the prior Roll Day
J₁₍ᵣ₎ is the weight (proportion) of C₁ Rolled on a day r, where
Σ J₁₍ₙ₎=1 has a range n=1 to d and
J₁₍ᵣ₎=1/d only where the amount Rolled is equally weighted during the Roll for each day r
F is a Net Adjustment Factor is embedded with the weights, where
F=(1−f %) and
f % is the percentage per annum rate for any debits minus the percentage per annum rate for any credits (applied as the relevant circumstances require)
Eₓ₍ᵣ₎=Eₓ₍ᵣ₋₁₎×(W₁₍ᵣ₎/W₁₍ᵣ₋₁₎)×F
except where a Roll Day (r>0) follows a Non Roll Day (r=0), then
Eₓ₍ᵣ₋₁₎=E_{(c-1)} (ie entitlement for the prior calendar day)
E_{y(r)}=Σ{Eₓ₍ₙ₋₁₎×(1/W₍ₙ₋₁₎)×(J₁₍ₙ₎×P₁₍ₙ₎/P₂₍ₙ₎)×F}=ΣE_{y(n)} where Σ has a range n=1 to r
such that E_{y(1)}+E_{y(2)}+ . . . +E_{y(r)}
R(r) is the security Reference Price on day r where R₍ᵣ₎=P₁₍ᵣ₎W₁₍ᵣ₎+P₂₍ᵣ₎(1−W₁₍ᵣ₎)
d is the total number of Roll Days on which the Roll takes place
r for a Roll Day r, is greater than 0 (zero), has values of 1 through d that correspond to the number of the Roll Day, and for which there is a corresponding calendar day c referring to the same day and,
for a Non-Roll day r, has a value of 0 (zero), and for which there is a corresponding calendar day c, referring to the same day
n a is an integer counter.

10. The computer program for managing an exchange traded, structured investment security of claim 6 wherein the entitlement E for any trading day t, is calculated by the formula:
for a Roll Day
E₍ₜ₎=E_{X(r)}+E_{Y(r)}
and,
for a Non Roll Day
E₍ₜ₎=E₍ₜ₋₁₎×F
where
E₍ₜ₎ is Entitlement on a trading day t in respect of a Roll day r where r>0
E₍ₜ₋₁₎ is Entitlement on the trading day prior to trading day t
t is a trading day to which there is a corresponding r and is not a Disruption Day
E_{X} is Entitlement in respect of the proportion of C₁ contracts not yet rolled
E_{Y} is Entitlement in respect of the proportion of C₁ contracts Rolled into C₂ contracts on the current Roll Day and previously rolled on prior Roll Days of the Roll period
E_{X(r)}=(P₁₍ᵣ₎×Eₓ₍ᵣ₎)/R₍ᵣ₎
E_{Y(r)}=(P₂₍ᵣ₎×E_{y(r))}/R₍ᵣ₎
P₁₍ᵣ₎ is the price of the Current Marker Contract C₁ on trading day t
P₂(r) is the price of the Next Marker Contract C₂ on trading day t
Eₓ₍ᵣ₎=Eₓ₍ᵣ₋₁₎×(W₁₍ᵣ₎/W₁₍ₙ₋₁₎)×F^{(m)}
E_{y(r)}=Σ{Eₓ₍ₙ₋₁₎×(1/W₁₍ₙ₋₁₎×(J₁₍ₙ₎×P₁₍ₙ₎/P₂₍ₙ₎×F^{(m)}}=ΣE_{y(n)} where Σ has a range n=1 to r
such that E_{y(1)}+E_{y(2)}+ . . . +(E_{y(r)}
Eₓ₍ᵣ₋₁₎ is Eₓ₍ᵣ₎ of the prior trading day and
where Eₓ₍ᵣ₋₁₎=Eₓ₍₀₎=E₍ₜ₎
F is the Net Adjustment Factor for the roll day is embedded with the weights, where
F=(1−f %) and
f % is the percentage per annum rate for any debits minus the percentage per annum rate for any credits (applied as the relevant circumstances require)
m is an integer counter in respect of F that is the number of days equal to the current trading day plus the number of non trading days since the prior trading day
and, if the quantum of F differs on one or more such days, F^{(m)}=F_{(c)}×F_{(c-1)}× . . . ×F_{(c-1)} where c is the current trading day and c−1 to n are non trading days since the prior trading day
W₁₍ᵣ₎ is the weight (proportion) accorded to the Current Marker Contract C₁ reflecting C₁ not yet rolled at the completion of trading day t that is a Roll day r, where
W₁₍ᵣ₎=1−ΣJ₁₍ₙ₎ Σ has a range, n=1 to r in the Roll period
W₁₍ᵣ₌₀₎=1 for a trading day outside the Roll period
W₁₍ᵣ₋₁₎ is the weight for the prior trading day
J₁₍ᵣ₎ is the weight (proportion) of C₁ Rolled on a day r, where
ΣJ₁₍ₙ₎=1 Σ has a range n=1 to d and
J₁₍ᵣ₎=1/d only where the amount Rolled is equally weighted during the Roll for each day r
d is the total number of Roll Days on which the Roll takes place
r for a Roll Day r, is greater than 0 (zero), has integer values of 1 through d that correspond to the number of the Roll Day, there is a corresponding trading day t referring to the same day and,
for a Non-Roll Day r, has a value of 0 (zero), there is a corresponding trading day t referring to the same day
n is an integer counter
R₍ₜ₎ is the security Reference Price on trading day t
where R₍ₜ₎=P₁₍ᵣ₎W₁₍ᵣ₎+P₂₍ᵣ₎(1−W₁₍ᵣ₎).

11. A computer program containing executable instructions for creating and managing an index on which an exchange traded, structured investment security is based the index tracking the price movements of the asset and is linked to the value or performance of the asset, the said asset having a forward price structure, a forward market, and an expiration date, in which the computer program is preloaded with data relating to said asset, reference price, entitlement, current and next marker contract prices, trading day dates and weightings and said computer program uses the preloaded information to roll the asset forward and into another asset with a later expiry date and said program calculates the index using the formula
I=R×E
where
I is the index
R is the Reference Price
E is the value based Entitlement of the Security
In which the reference price is calculated by the formula
R=P₁W₁+P₂(1−W₁)
where
R is the Reference Price
P₁ is the price of the Current Marker Contract C₁
P₂ is the price of the Next Marker Contract C₂
W₁ is the weight accorded to the Current Marker Contract C₁ at the completion of any calendar day, where
0≦W₁≦1 for any calendar day that is a Roll Day
W₁=1 for any calendar day that is a Non-Roll Day
P₁ and P₂ are both market prices of the asset during the trading day or both end-of-day prices as the relevant circumstances require where the end-of-day price is the published price for the asset contract as determined in accordance with the rules, regulations and procedures of the relevant asset market and laws of the relevant jurisdiction in which entitlement is the notional claim on the underlying asset rolled forward.
